(19) United States
(12) Patent Application Publication
(10) Pub. No.: US 2014/0198239 A1
(43) Pub. Date: Jul. 17, 2014

(54) IMAGING APPARATUS AND IMAGING METHOD

(71) Applicant: SONY CORPORATION, Tokyo (JP)

(72) Inventors: ASUKA SUZUKI, Tokyo (JP); MAKIBI NAKAMURA, Tokyo (JP); KEIJIRO YOSHIMATSU, Kanagawa (JP); MANABU KUBO, Tokyo (JP)

(73) Assignee: SONY CORPORATION, Tokyo (JP)

(21) Appl. No.: 14/141,169

(22) Filed: Dec. 26, 2013

(30) Foreign Application Priority Data
Jan. 17, 2013 (JP) 2013-005841

(51) Int. Cl. H04N 5/232; H04N 5/217; H04N 5/367

(52) U.S. Cl. CPC H04N 5/23212; H04N 5/3675; H04N 5/2171
USPC 348/246

(57) ABSTRACT

There is provided an imaging apparatus including: an imaging device that includes a plurality of pairs of phase difference detection pixels, where a plurality of phase difference lines along pupil division directions is disposed in an orthogonal direction which is orthogonal to the pupil division direction; a detection unit that detects an abnormal value among output values, which are output by the phase difference detection pixels, on the basis of a result of comparison of the output values between the plurality of phase difference lines; and a phase difference line determination unit that determines, as used lines, a plurality of phase difference lines, which are used in phase difference detection, among the plurality of phase difference lines in a phase difference detection region, on the basis of a detection result which is obtained by the detection unit.

### CROSS REFERENCE TO RELATED APPLICATIONS

This application claims the benefit of Japanese Priority Patent Application JP 2013-005841 filed Jan. 17, 2013, the entire contents of which are incorporated herein by reference.

### BACKGROUND

The present technology relates to an imaging apparatus, and particularly, relates to an imaging apparatus, which performs phase difference detection, and an imaging method therefor.

Recently, imaging apparatuses such as a digital still camera, which captures an image of a subject such as a person, generates a captured image, and records the generated captured image, have come into widespread use. Further, as the imaging apparatuses, imaging apparatuses which have an auto focus (AF) function of automatically adjusting a focus (focal point) at the time of the image capturing in order to simplify a photographing operation of a user, have come into widespread use.

As the imaging apparatuses, for example, there has been proposed an imaging apparatus that performs auto focus in a contrast detection method of capturing a plurality of images while shifting a focus position and setting the focus position with highest contrast as an in-focus position. Further, there has also been proposed an imaging apparatus that performs auto focus in a phase difference detection method of positioning an imaging lens by forming a pair of images through pupil division of light, which is transmitted through an imaging lens, and measuring (detecting the phase difference) the interval between the formed images.

Furthermore, there has also been proposed an imaging apparatus that has both functions of the contrast detection method and the phase difference detection method. As the imaging apparatus, for example, there has been proposed an imaging apparatus in which a single imaging device is provided with both of pixels (phase difference detection pixels), which perform pupil division on the light transmitted through an imaging lens, and pixels (image generation pixels) which are for generating a captured image (for example, refer to Japanese Unexamined Patent Application Publication No. 2009-204987).

### SUMMARY

In the above-mentioned related art, both the phase difference detection pixels and the image generation pixels are provided in the single imaging device. Hence, by using only the single imaging device, it is possible to perform both the phase difference detection and the image generation.

In addition, in such an imaging device, a defective pixel may be present in the phase difference detection pixels. In this case, for example, the defective pixel is corrected in a similar manner to correction of a pixel value of a defective pixel in the image generation pixels. Consequently, the pixel value of the defective pixel is corrected from an average value of the pixel values of the phase difference detection pixels (phase difference detection pixels receiving light, which is subjected to the pupil division, in the same direction as the defective pixel) which are close to the defective pixel.

However, a defective pixel may be positioned at the edge of a high frequency image, or there may be a region in which defective pixels are aggregated. In this case, it is conceivable that it is difficult to appropriately perform the correction due to the effects of the high-frequency component and the defective pixels. Further, when a pixel generates an abnormal value due to a foreign particle attached thereto in use, it is conceivable that the abnormal value is used in the phase difference detection and thus the degree of accuracy in the phase difference detection is lowered.

Accordingly, it is important to perform phase difference detection with high accuracy even when performing the phase difference detection at the position of a phase difference detection pixel which generates the abnormal value due to the defect, the foreign particle, or the like.

The present technology has been made in view of the above situation, and it is desirable to improve the accuracy in the phase difference detection.

According to a first embodiment of the present technology, there are provided an imaging apparatus and an imaging method. The imaging apparatus includes: an imaging device that includes a plurality of pairs of phase difference detection pixels, where a plurality of phase difference lines along pupil division directions is disposed in an orthogonal direction which is orthogonal to the pupil division direction; a detection unit that detects an abnormal value among output values, which are output by the phase difference detection pixels, on the basis of a result of comparison of the output values between the plurality of phase difference lines; and a phase difference line determination unit that determines, as used lines, a plurality of phase difference lines, which are used in phase difference detection, among the plurality of phase difference lines in a phase difference detection region, on the basis of a detection result which is obtained by the detection unit. In this case, it is possible to obtain the following effect: the abnormal value, which is output by the phase difference detection pixel, is detected on the basis of the result of the comparison of the output values between the plurality of phase difference lines in the phase difference detection target region, and the plurality of phase difference lines, which are used in phase difference detection, is determined on the basis of the detection result.

Further, in the first embodiment, the phase difference line determination unit may determine the used lines by excluding an abnormal value line, which is a phase difference line including the phase difference detection pixel that outputs the abnormal value, from the plurality of phase difference lines. In this case, it is possible to obtain an effect that excludes the abnormal value line from the plurality of phase difference lines which are used in phase difference detection.

Further, in the first embodiment, the detection unit may calculate a line total for each of the phase difference lines by performing computation using the output values of the phase difference detection pixels included in the phase difference line, and may detect the abnormal value line on the basis of a result of comparison between the line totals. In this case, it is possible to obtain an effect that the abnormal value line is detected using the line total.

Further, in the first embodiment, the detection unit may detect the abnormal value line on the basis of a result of comparison between a predetermined threshold value and the line totals, may set a new region when detecting a plurality of the abnormal value lines, and may detect the abnormal value line on the basis of a result of comparison between the line totals in the new region. In this case, it is possible to obtain an effect that a new region is set when the plurality of abnormal value lines is detected.

Further, in the first embodiment, the detection unit may calculate the line total for each of a base region and a reference region which are set to perform correlation calculation in a phase difference detection target region including the plurality of phase difference lines, and may detect the abnormal value line for each of the base region and the reference region. In this case, it is possible to obtain an effect that the abnormal value line is detected for each of the base region and the reference region.

Further, in the first embodiment, the detection unit may detect the abnormal value line in the base region on the basis of the line total which is obtained by adding the output values of one of the pair of phase difference detection pixels, and may detect the abnormal value line in the reference region on the basis of the line total which is obtained by adding the output values of the other of the pair of phase difference detection pixels. In this case, it is possible to obtain the following effect: the abnormal value line in the base region is detected on the basis of the line total which is obtained by adding the output values of one (base side) of the pair of phase difference detection pixels, and the abnormal value line in the reference region is detected on the basis of the line total which is obtained by adding the output values of the other (reference side) of the pair of phase difference detection pixels.

Further, in the first embodiment, the phase difference line determination unit may determine whether or not it is possible to perform the phase difference detection using alternative candidates as the output values of the phase difference lines, which are disposed near the abnormal value line as the phase difference line including the phase difference detection pixel that outputs the abnormal value, instead of the output values of the abnormal value line, and may determine the plurality of phase difference lines, which include the abnormal value line, as the used lines on the basis of the detection result which is obtained by the detection unit when determining that it is possible to perform the phase difference detection. In this case, it is possible to obtain the following effect: the phase difference detection is performed using the output values of the phase difference lines, which are disposed near the abnormal value line, instead of the output values of the phase difference detection pixels in the abnormal value line.

Further, in the first embodiment, in the imaging device, a plurality of phase difference detection pixels corresponding to any of a plurality of exit pupils, of which positions are different in an optical axis direction, may be disposed. In addition, in the difference phase lines, the phase difference detection pixels may be arranged such that one phase difference line corresponds to the exit pupil at one position, and the phase difference lines may be arranged to respectively correspond to the exit pupils different from the exit pupils corresponding to the phase difference lines adjacent in the orthogonal direction. In addition, a focusing determination unit may set the output values of the phase difference line, of which the corresponding exit pupil is closer to the exit pupil corresponding to the abnormal value line, between the two phase difference lines, which are adjacent to the abnormal value line in the orthogonal direction, as the alternative candidates. In this case, it is possible to obtain the following effect: the phase difference detection may be performed by using the output values of the phase difference line, which is close to the exit pupil corresponding to the abnormal value line, among the phase difference lines which are adjacent to the abnormal value line, instead of the output values of the phase difference detection pixels in the abnormal value line.

Further, in the first embodiment, in the imaging device, a plurality of phase difference detection pixels corresponding to any of a plurality of exit pupils, of which positions are different in an optical axis direction, may be disposed. In addition, in the difference phase lines, the phase difference detection pixels may be arranged such that one phase difference line corresponds to the exit pupil at one position, and the phase difference lines may be arranged to respectively correspond to the exit pupils different from the exit pupils corresponding to the phase difference lines adjacent in the orthogonal direction. In addition, the phase difference line determination unit may calculate the alternative candidates by computing the output values of the two phase difference lines which are adjacent to the abnormal value line in the orthogonal direction. In this case, it is possible to obtain the following effect: the phase difference detection may be performed by using the alternative candidates, which are calculated by computing the output values of the phase difference lines which are adjacent to the abnormal value line, instead of the output values of the phase difference detection pixels in the abnormal value line.

According to embodiments of the present technology, it is possible to obtain an excellent effect that improves accuracy in the phase difference detection.

### BRIEF DESCRIPTION OF THE DRAWINGS

FIG. 1 is a schematic diagram illustrating an example of an internal configuration of an imaging system according to a first embodiment of the present technology;

FIG. 2 is a cross-sectional view schematically illustrating an example of a configuration of a cross-section of the imaging apparatus in the imaging system according to the first embodiment of the present technology, and in the drawing, it is assumed that the imaging system is a single-lens camera;

FIG. 3 is a block diagram illustrating an example of a functional configuration of the imaging system according to the first embodiment of the present technology;

FIG. 4 is a schematic diagram illustrating an example of arrangement of pixels provided in an imaging device according to the first embodiment of the present technology;

FIG. 5 is a diagram schematically illustrating a focus area which is set in the imaging device according to the first embodiment of the present technology;

FIGS. 6A and 6B are diagrams schematically illustrating examples of abnormality detection which is performed on a row-by-row basis by an abnormal value line detection unit in the first embodiment of the present technology;

FIG. 7 is a schematic diagram illustrating a relationship between the abnormal value lines, which are detected by the abnormal value line detection unit, and correlation calculation, which is performed by a defocus amount calculation unit, in the first embodiment of the present technology;

FIGS. 8A to 8C are schematic diagrams illustrating relationships between the abnormal value lines, which are detected by the abnormal value line detection unit, and correlation calculation, which is performed by the defocus amount calculation unit, in the first embodiment of the present technology;

FIG. 9 is a flowchart illustrating an example of an imaging processing procedure of the imaging apparatus according to the first embodiment of the present technology;

FIG. 10 is a flowchart illustrating an example of a procedure of a focusing process in the imaging processing procedure according to the first embodiment of the present technology;

FIG. 11 is a flowchart illustrating an example of a procedure of an abnormality detection process in the imaging processing procedure according to the first embodiment of the present technology;

FIG. 12 is a flowchart illustrating an example of a procedure of a correlation calculation process in the imaging processing procedure according to the first embodiment of the present technology;

FIG. 13 is a schematic diagram illustrating an example of arrangement of pixels provided in an imaging device according to a second embodiment of the present technology;

FIGS. 14A to 14C are diagrams schematically illustrating pupil division, which is performed by phase difference detection pixels respectively corresponding to exit pupils at three positions, in the second embodiment of the present technology;

FIG. 15 is a diagram schematically illustrating an example of the abnormality detection which is performed on a row-by-row basis by an abnormal value line detection unit in the imaging device according to the second embodiment of the present technology;

FIG. 16 is a diagram schematically illustrating an example of determination that is made as to whether or not to use the phase difference line, which corresponds to the exit pupil at another position, as a substitute by the abnormal value line detection unit, in the second embodiment of the present technology;

FIG. 17 is a flowchart illustrating an example of an imaging processing procedure of an imaging apparatus according to the second embodiment of the present technology;

FIG. 18 is a flowchart illustrating an example of a procedure of a process of determining the pattern of the pupils for phase difference detection in the imaging processing procedure according to the second embodiment of the present technology;

FIG. 19 is a flowchart illustrating an example of a procedure of an abnormality detection process in the imaging processing procedure according to the second embodiment of the present technology;

FIG. 20 is a flowchart illustrating an example of a procedure of an alternative line setting process in the imaging processing procedure according to the second embodiment of the present technology;

FIG. 21 is a flowchart illustrating an example of a procedure of a correlation calculation process in the imaging processing procedure according to the second embodiment of the present technology;

FIG. 22 is a flowchart illustrating an example of a procedure of an alternative line setting process in an imaging processing procedure according to a third embodiment of the present technology;

FIG. 23 is a flowchart illustrating an example of a procedure of an abnormality detection process in an imaging processing procedure according to a fourth embodiment of the present technology;

FIG. 24 is a flowchart illustrating an example of a procedure of a multi-line abnormality detection process in the imaging processing procedure according to the fourth embodiment of the present technology;

FIG. 25 is a diagram illustrating an example of an abnormality detection region in the fourth embodiment of the present technology;

FIG. 26 is a diagram illustrating an example of pixel arrangement in the imaging device, which is able to perform reading on the row-by-row basis and in which phase difference detection pixels performing pupil division in the column direction (vertical direction) are disposed on a column-by-column basis, as a modified example of the embodiment of the present technology;

FIG. 27 is a diagram illustrating an example in which the phase difference detection pixels performing the pupil division in the row direction (horizontal direction) are respectively disposed at separate rows in the imaging device, which is able to perform reading on the row-by-row basis, as a modified example of the embodiment of the present technology; and

FIG. 28 is a diagram illustrating an example in which the phase difference detection pixels performing the pupil division in the column direction (vertical direction) are respectively disposed at separate rows in the imaging device, which is able to perform reading on the row-by-row basis, as a modified example of the embodiment of the present technology.

### DETAILED DESCRIPTION OF EMBODIMENTS

Hereinafter, modes for carrying out the present technology (hereinafter referred to as embodiments) will be described. The description will be given in order of the following:

1. First Embodiment (imaging control: an example of correlation calculation which is performed excluding the abnormal value line);
2. Second Embodiment (imaging control: an example of correlation calculation in which the output values of the abnormal value line are substituted by the output values of one of the lines adjacent thereto);
3. Third Embodiment (imaging control: an example of correlation calculation in which the output values of the abnormal value line are substituted by an average of the output values of the adjacent line);
4. Fourth Embodiment (imaging control: an example in which the abnormality detection region is changed); and

### 5. Modified Example.

### 1. First Embodiment

### Internal Configuration Example of Imaging System

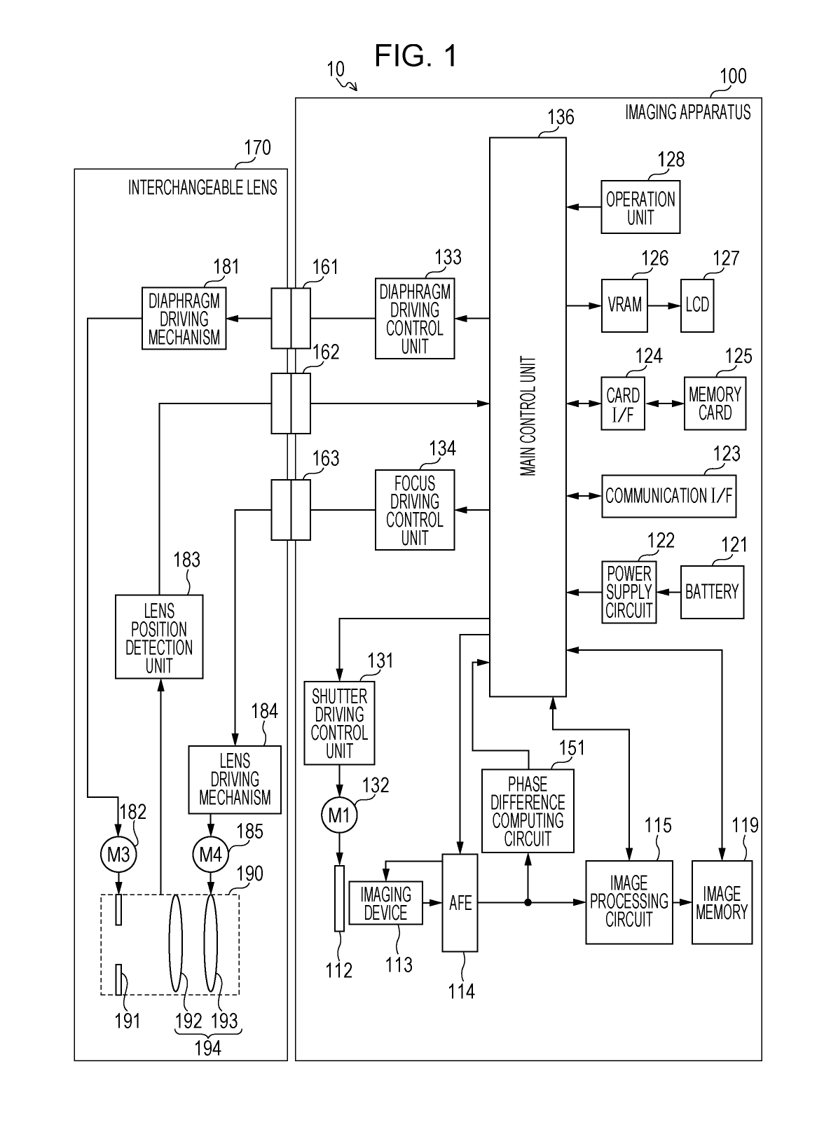

FIG. 1 is a schematic diagram illustrating an example of an internal configuration of an imaging system 10 according to a first embodiment of the present technology.

The imaging system 10 generates image data (captured image) by capturing an image of a subject, and records the generated image data as image content (still image content or moving image content). The system includes an imaging apparatus 100 and an interchangeable lens 170. It should be noted that the following description will be given focusing on an exemplary case where the still image contents (still image file) are recorded as the image contents (image file).

In addition, in the first embodiment of the present technology, it is assumed that the imaging system 10 is a single-lens camera of which the lens is exchangeable and which is able to capture an image. In addition, in FIG. 1, for convenience of description, internal configurations (for example, a configuration of a flash), which are not much used when an image is intended to be captured, will be omitted.

Further, in FIG. 1, for convenience of description, regarding driving of lenses, only a configuration of driving of a focus lens will be described, and a configuration of driving of a zoom lens will be omitted.

The imaging system 10 includes the imaging apparatus 100 and the interchangeable lens 170.

The imaging apparatus 100 generates image data (digital data) by capturing an image of a subject, and records the generated image data as image content (still image content or moving image content). It should be noted that the following description will be given focusing on an exemplary case where the still image contents (still image file) are recorded as the image contents (image file). The imaging apparatus 100 includes a shutter unit 112, an imaging device 113, an analog front end (AFE) 114, an image processing circuit 115, and a phase difference computing circuit 151. Further, the imaging apparatus 100 includes an image memory 119, a battery 121, a power supply circuit 122, a communication interface (I/F) 123, a card I/F 124, and a memory card 125. Furthermore, the imaging apparatus 100 includes a video random access memory (VRAM) 126, a liquid crystal display (LCD) 127, an operation unit 128, and a shutter driving control unit 131. Further, the imaging apparatus 100 includes a shutter driving motor (M1) 132, a diaphragm driving control unit 133, a focus driving control unit 134, a main control unit 136, and connection terminals 161 to 163.

The shutter unit 112 is driven by the shutter driving motor (M1) 132 so as to open and close the optical path of light, which is incident from a subject to the imaging device 113, by using a screen which is movable in the vertical direction. Further, when the optical path is open, the shutter unit 112 supplies the light, which is incident from the subject, to the imaging device 113.

The imaging device 113 photoelectrically converts the light, which is incident from the subject, into an electric signal. That is, the imaging device 113 receives the light which is incident from the subject, and generates an analog electric signal. Further, the imaging device 113 is realized by, for example, a complementary metal oxide semiconductor (CMOS) sensor and a charge coupled device (CCD) sensor. In the imaging device 113, pixels (image generation pixels), which generate a signal for generating a captured image on the basis of the received subject light, and pixels (phase difference detection pixels), which generate a signal for performing phase difference detection, are arranged. Here, the phase difference detection is defined as a focus detection method of detecting a level of focusing by forming a pair of images through pupil division of light, which is transmitted through an imaging lens, and measuring (detecting the phase difference) the interval (the shift amount between the images) between the formed images. Consequently, pairs of two phase difference detection pixels, which receive either of a pair of pupil-divided rays of the subject, are disposed.

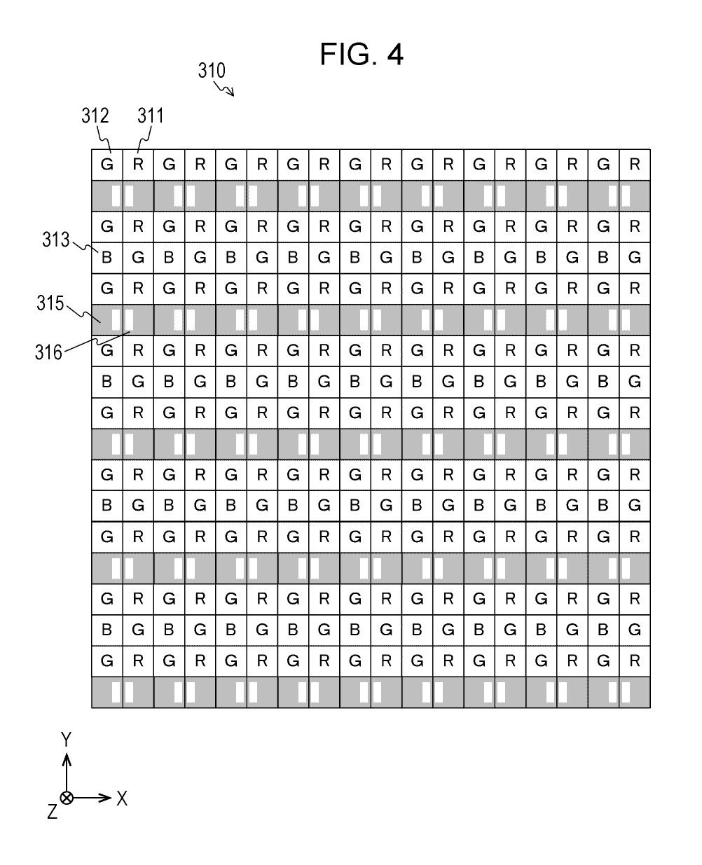

Further, in the imaging device 113, as image generation pixels, pixels, which receive red light (R pixels) using a color filter transmitting red (R) light, and pixels, which receive green light (G pixels) using a color filter transmitting green (G) light, are disposed. Further, in the imaging device 113, in addition to the R pixels and G pixels, as image generation pixels, pixels, which receive blue light (B pixels) using a color filter transmitting blue (B) light, are disposed. It should be noted that the imaging device 113 will be described with reference to FIG. 4. The imaging device 113 supplies an electric signal (analog image signal) generated by photoelectric conversion thereof to the AFE 114.

The AFE 114 performs predetermined signal processing on the analog image signal supplied from the imaging device 113. For example, the AFE 114 performs signal processing, such as noise removal and signal amplification, on the analog image signal. Then, the AFE 114 converts the image signal, which is subjected to the signal processing, into a digital signal so as to generate a digital image signal. Further, the AFE 114 generates a timing pulse for an imaging operation of the imaging device 113 on the basis of a reference clock supplied from the main control unit 136, and supplies the generated timing pulse thereof to the imaging device 113. Further, the AFE 114 supplies a signal for an operation of the imaging device 113, such as notification of start or end of an exposure operation of the imaging device 113 which is set by the main control unit 136 or notification of output selection of each pixel of the imaging device 113, in sync with the generated timing pulse thereof. The AFE 114 supplies the generated digital image signal (pixel values) to the image processing circuit 115 and the phase difference computing circuit 151.

The image processing circuit 115 performs the predetermined signal processing on the image signal supplied from the AFE 114, thereby correcting the image signal. The image processing circuit 115 performs, for example, black level correction, defect correction, shading correction, color mixture correction, demosaic processing, white balance correction, γ correction, and the like. The image processing circuit 115 supplies the signal, which is subjected to the processing (for example, all the corrections mentioned above) necessary for displaying and recording the captured image, to the image memory 119.

Further, the image processing circuit 115 performs processing of encoding or decoding the image, at the time of performing processing of recording the captured image in the memory card 125, processing of reproducing the recorded image, or the like. For example, in a case of saving images (frames) consecutively captured in a time sequence as a moving image, the image processing circuit 115 detects a motion vector from a difference between frames, and performs encoding processing based on inter-frame prediction using the detected motion vector.

The phase difference computing circuit 151 is to detect defocus in the phase difference detection method, on the basis of the image signal which is generated from the phase difference detection pixels supplied from the AFE 114. Here, the phase difference detection method is defined as a focus detection method of detecting a level of focusing by forming a pair of images through pupil division of light, which is transmitted through an imaging lens, and measuring (detecting the phase difference) the interval (the shift amount between the images) between the formed images. The phase difference computing circuit 151 performs computation for detecting defocus of a focusing target object, in order to perform auto focus (AF), and supplies information on the detected focus to the main control unit 136.

The image memory 119 is to temporarily hold the image signal supplied from the image processing circuit 115. Further, this image memory 119 is used as a work area for performing the predetermined processing on the image signal in accordance with a control signal from the main control unit 136. In addition, this image memory 119 temporarily holds an image signal which is read out from the memory card 125.

The battery 121 is to supply electric power for operations of the imaging system 10, and is formed as a secondary battery such as a nickel hydrogen battery. Further, the battery 121 supplies electric power to the power supply circuit 122.

The power supply circuit 122 is to convert the electric power supplied from the battery 121 into a voltage for operating the units in the imaging system 10. For example, this power supply circuit 122 generates a voltage of 5 V when the main control unit 136 operates at the voltage of 5 V, and supplies the generated voltage to the main control unit 136. Further, the power supply circuit 122 supplies the generated voltage to the units of the imaging system 10. It should be noted that FIG. 1 shows power supply lines from the power supply circuit 122 to the units in a partially omitted manner.

The communication I/F 123 is an interface to enable data transfer between an external device and the main control unit 136.

The card I/F 124 is an interface to enable data transfer between the memory card 125 and the main control unit 136.

The memory card 125 is a storage medium for holding image signals, and holds data which is supplied through the card I/F 124.

The VRAM 126 is a buffer memory which temporarily holds an image to be displayed on the LCD 127, and supplies the held image thereof to the LCD 127.

The LCD 127 is to display an image on the basis of the control of the main control unit 136, and is constituted of, for example, a color liquid crystal panel. The LCD 127 displays the captured image, a recorded image, a mode setting screen, and the like.

The operation unit 128 is to receive a user's operation. For example, when a shutter button (not shown in the drawing) has been pressed, the operation unit 128 supplies a signal to inform the pressing to the main control unit 136. Further, the operation unit 128 supplies a signal for the user's operation to the main control unit 136.

The shutter driving control unit 131 is to generate a driving signal for driving the shutter driving motor (M1) 132, on the basis of a shutter control signal supplied from the main control unit 136, and supplies the generated driving signal to the shutter driving motor (M1) 132.

The shutter driving motor (M1) 132 is a motor which drives the shutter unit 112 on the basis of the driving signal supplied from the shutter driving control unit 131.

The diaphragm driving control unit 133 is to generate a signal, which is for controlling driving of diaphragm (diaphragm driving control signal), on the basis of diaphragm information supplied from the main control unit 136, and supplies the generated diaphragm driving signal thereof to the interchangeable lens 170 through the connection terminal 161.

The main control unit 136 is to control operations of the units of the imaging apparatus 100, and is constituted of, for example, a microcomputer including ROM which stores a control program.

The focus driving control unit 134 is to generate a driving amount signal indicating the driving amount of the lens, on the basis of the focus information supplied from the main control unit 136. The focus driving control unit 134 supplies the generated driving amount signal thereof to the interchangeable lens 170 through the connection terminal 163.

The interchangeable lens 170 includes a plurality of lenses, and is to concentrate light of an image captured by the imaging apparatus 100 and to form an image on an imaging surface from the concentrated light. The interchangeable lens 170 includes a diaphragm driving mechanism 181, a diaphragm driving motor (M3) 182, a lens position detection unit 183, a lens driving mechanism 184, a lens driving motor (M4) 185, and a lens barrel 190. Further, the lens barrel 190 includes a diaphragm 191 and a lens group 194. It should be noted that, for convenience of description, only a zoom lens 192 and a focus lens 193 in the lens group 194 are shown.

The diaphragm driving mechanism 181 is to generate a driving signal for driving the diaphragm driving motor (M3) 182, on the basis of the diaphragm driving control signal supplied through the connection terminal 161. The diaphragm driving mechanism 181 supplies the generated driving signal thereof to the diaphragm driving motor (M3) 182.

The diaphragm driving motor (M3) 182 is a motor for driving the diaphragm 191, on the basis of the driving signal supplied from the diaphragm driving mechanism 181. The diaphragm driving motor (M3) 182 changes the diaphragm diameter of the diaphragm 191 by driving the diaphragm 191.

The lens position detection unit 183 is to detect the positions of the zoom lens 192 and focus lens 193 of the lens group 194. The lens position detection unit 183 supplies information on the detected positions thereof (lens position information) to the imaging apparatus 100 through the connection terminal 162.

The lens driving mechanism 184 is to generate a driving signal for driving the lens driving motor (M4) 185, on the basis of the driving amount signal supplied through the connection terminal 163. The lens driving mechanism 184 supplies the generated driving signal thereof to the lens driving motor (M4) 185.

The lens driving motor (M4) 185 is a motor for driving the focus lens 193, on the basis of the driving signal supplied from the lens driving mechanism 184. The lens driving motor (M4) 185 adjusts the focus by driving the focus lens 193.

The lens barrel 190 is a section in which lenses constituting the lens group 194 in the interchangeable lens 170 are provided.

The diaphragm 191 is a blocking object for adjusting the amount of light which is incident from a subject to the imaging apparatus 100.

The zoom lens 192 is to adjust the scale factor of a subject included in the captured image by moving the lens in the optical axis direction inside the lens barrel 190 so as to change the focal length thereof.

The focus lens 193 is to adjust the focus by moving the lens in the optical axis direction inside the lens barrel 190.

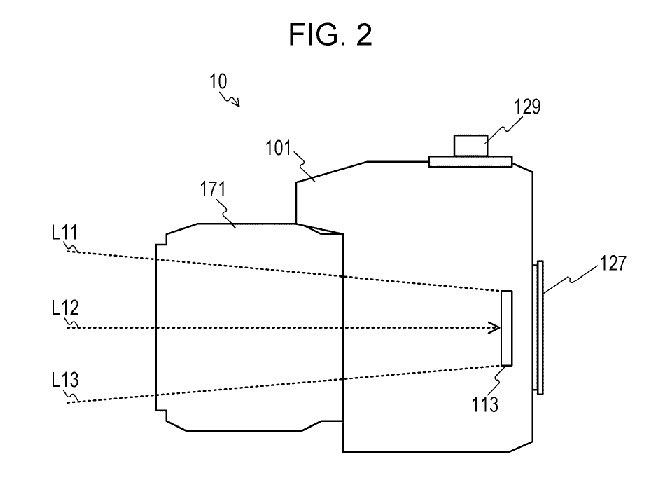

Next, the functional configuration of the imaging system 10 will be described with reference to FIG. 2.

Cross-Section Configuration Example of Imaging Apparatus

FIG. 2 is a cross-sectional view schematically illustrating an example of a configuration of a cross-section of the imaging apparatus in the imaging system 10 according to the first embodiment of the present technology. In addition, in the drawing, it is assumed that the imaging system 10 is a single-lens camera.

FIG. 2 as a cross-sectional view of the imaging system 10 shows a body 101 and an interchangeable lens 171. The interchangeable lens 171 is a lens unit which is interchangeable in the imaging system 10, and corresponds to the interchangeable lens 170 shown in FIG. 1. The body 101 is a main body which performs imaging processing of the imaging apparatus 100, and corresponds to the imaging apparatus 100 shown in FIG. 1. In the body 101, a shutter button 129, the LCD 127, and the imaging device 113 are shown.

Further, FIG. 2 shows the optical axis (optical axis L12) of lenses, which are provided in the interchangeable lens 170, and two lines (lines L11 and L13) which indicate a range in which the subject light is transmitted. In addition, the range between the lines L11 and L13 indicates a range in which the light incident into the imaging device 113 is transmitted.

As shown in FIG. 2, the subject light incident into the imaging system 10 is entirely incident into the imaging device 113. That is, when the phase difference detection is performed in the imaging system 10, the detection is performed by the signal which is generated by the imaging device 113. Further, a live-view image and a still image are generated using the signal which is generated by the imaging device 113.

Functional Configuration Example of Imaging Apparatus

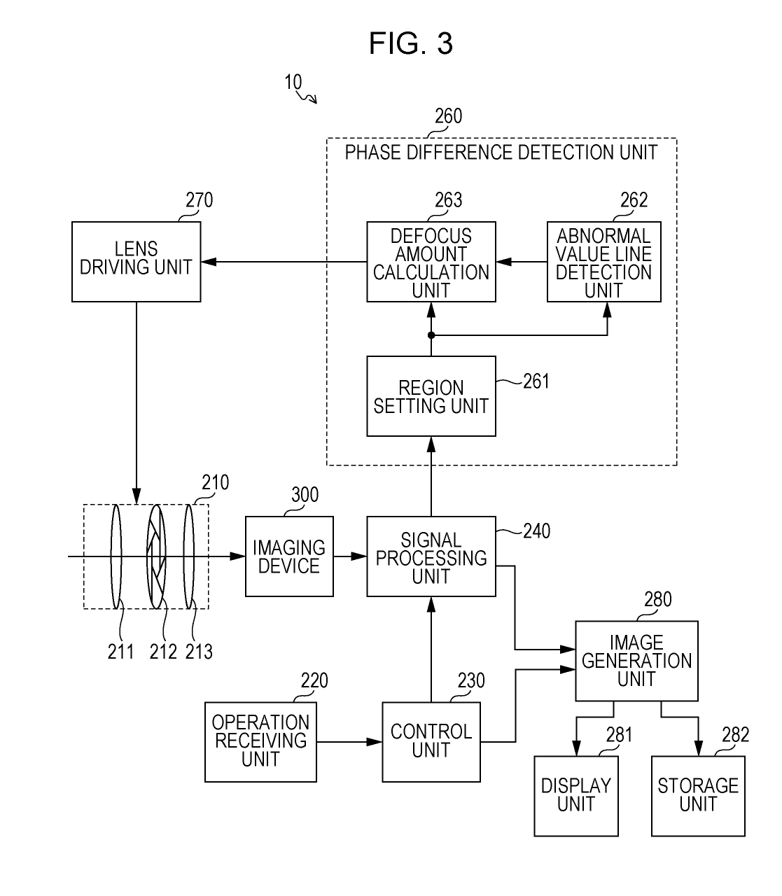

FIG. 3 is a block diagram illustrating an example of a functional configuration of the imaging system 10 according to the first embodiment of the present technology.

The imaging system 10 includes a lens unit 210, an operation receiving unit 220, a control unit 230, an imaging device 300, a signal processing unit 240, a phase difference detection unit 260, a lens driving unit 270, an image generation unit 280, a display unit 281, and a storage unit 282.

The lens unit 210 is to concentrate the light (subject light) emitted from the subject. The lens unit 210 includes a zoom lens 211, a diaphragm 212, and a focus lens 213.

The zoom lens 211 is to adjust the scale factor of the subject included in the captured image by moving the lens in the optical axis direction through driving of the lens driving unit 270 so as to change the focal length thereof. The zoom lens 211 corresponds to the zoom lens 192 shown in FIG. 1.

The diaphragm 212 is a blocking object for adjusting the amount of the subject light, which is incident to the imaging apparatus 300, by changing a degree of opening through driving of the lens driving unit 270. The diaphragm 212 corresponds to the diaphragm 191 shown in FIG. 1.

The focus lens 213 is to adjust the focus by moving the lens in the optical axis direction through the driving of the lens driving unit 270. The focus lens 213 corresponds to the focus lens 193 shown in FIG. 1.

The operation receiving unit 220 receives an operation from a user. For example, when a shutter button (not shown in the drawing) has been pressed, the operation receiving unit 220 supplies a signal of the pressing as an operation signal to the control unit 230. In addition, the operation receiving unit 220 corresponds to the operation unit 128 shown in FIG. 1.

The control unit 230 is to control the operations of the imaging system 10. It should be noted that, in FIG. 3, only principal signal lines are shown, and the other lines are omitted. For example, when the shutter button has been pressed and the operation signal for starting recording the still image is received, the control unit 230 supplies a signal, which is for execution of the recording of the still image, to the signal processing unit 240 and the image generation unit 280. In addition, the control unit 230 corresponds to the main control unit 136 shown in FIG. 1.

The imaging device 300 is an image sensor which photoelectrically converts the received subject light into an electric signal. The imaging device 300 supplies the electric signal (image signal), which is generated by the photoelectric conversion, to the signal processing unit 240. In addition, the imaging device 300 corresponds to the imaging device 113 shown in FIG. 1, and will be described with reference to FIG. 4, and thus the detailed description thereof is omitted herein. In addition, the arrangement of pixels in the first embodiment of the present technology will be described in FIG. 4, and thus the detailed description thereof will be omitted. In the imaging device 300, pairs of phase difference detection pixels are linearly disposed at a single row.

The signal processing unit 240 performs the predetermined signal processing on the electric signal supplied from the imaging device 300, thereby correcting the image signal. For example, after converting the electric signal supplied from the imaging device 300 into a digital electric signal (pixel values), the signal processing unit 240 performs black level correction, defect correction, shading correction, mixed color correction, and the like. In addition, in the defect correction, a pixel value of a pixel (defective pixel), which does not normally function, among the image generation pixels disposed in the imaging device 300 is corrected by performing estimation based on the pixel values of pixels around the defective pixel.

Further, in the defect correction performed by the signal processing unit 240, the defective pixel among the image generation pixels is corrected, but the defective pixel among the phase difference detection pixels is not corrected. The signal processing unit 240 supplies some pixel values (output values of the phase difference detection pixels) among the pixel values subjected to the correction processes to the phase difference detection unit 260. The some pixel values are generated by the phase difference detection pixels which are disposed in a region (focus area) for focusing determination based on the phase difference detection. Further, the signal processing unit 240 supplies pixel values (pixel values of image generation pixels), which are generated by the image generation pixels, among the pixel values subjected to the correction processes to the image generation unit 280. In addition, the signal processing unit 240 corresponds to the AFE 114 and the image processing circuit 115 shown in FIG. 1.

The image generation unit 280 is to generate image data to be displayed on the display unit 281 or image data to be stored in the storage unit 282 by performing predetermined signal processing on the image signal which is generated by the image generation pixels supplied from the signal processing unit 240. The image generation unit 280 performs, for example, white balance correction, γ correction, demosaic processing, image compression processing, and the like, on the image signal. The image generation unit 280 supplies the image data to be displayed on the display unit 281 to the display unit 281, thereby displaying the image data on the display unit 281. Further, the image generation unit 280 supplies the image data to be stored in the storage unit 282 to the storage unit 282, thereby storing the image data in the storage unit 282. In addition, the image generation unit 280 corresponds to the image processing circuit 115 shown in FIG. 1.

The display unit 281 displays an image on the basis of the image data which is supplied from the image generation unit 280, and corresponds to the LCD 127 shown in FIG. 1.

The storage unit 282 stores the image data, which is supplied from the image generation unit 280, as an image content (image file). For example, as the storage unit 282, it may be possible to use a removable recording medium (one or a plurality of recording media) including a disc such as digital versatile disc (DVD), a semiconductor memory such as a memory card, and the like. Further, the recording medium may be built into the imaging system 10, and may be removable from the imaging system 10. In addition, the storage unit 282 corresponds to the storage unit 282 shown in FIG. 1.

The phase difference detection unit 260 is to determine whether or not the object (focusing target object) as a target of focus is in focus, through the phase difference detection, on the basis of the output values of the phase difference detection pixels supplied from the signal processing unit 240. The phase difference detection unit 260 calculates an amount of mismatch in focus (defocus amount) on the focusing target object, and calculates a driving amount of the focus lens 213, which is necessary for focusing, on the basis of the calculated defocus amount. Then, the phase difference detection unit 260 supplies information, which indicates the driving amount of the focus lens 213, to the lens driving unit 270.

In addition, FIG. 3 shows a region setting unit 261, an abnormal value line detection unit 262, and a defocus amount calculation unit 263, as functional components of the phase difference detection unit 260.

The region setting unit 261 sets regions (base region, reference region) for calculating correlation between a pair of images in a region (focus area) on which the focusing determination is performed. Here, the base region is a region where pixels generating output values (pixel values) as base values are disposed. The base output values are used when partial regions are set in the focus area and correlation therebetween is calculated. Further, the reference region has the same size as the base region, and is a region where pixels generating output values compared with the base values, which are used when the correlation is calculated, are disposed. The position of the reference region is the same as the position of the base region in a direction orthogonal to a pupil division direction, and the positions are different in the pupil division direction.

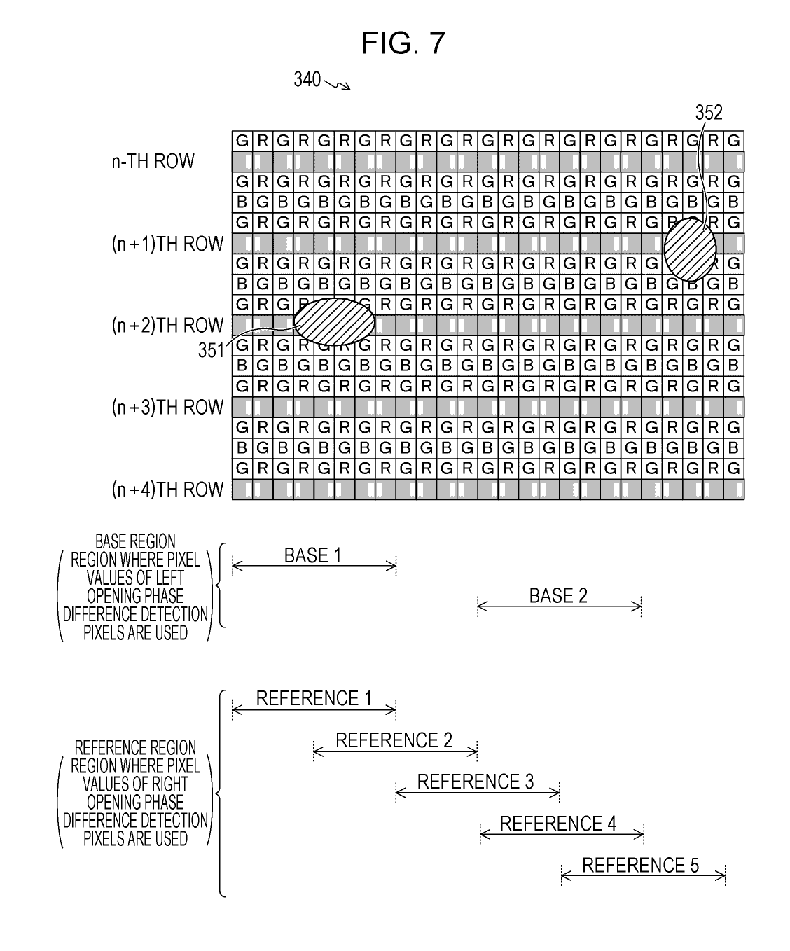

Here, the pupil division direction is defined as a direction in which the pair of regions of the exit pupil divided by the pupil division are adjacent to each other. In the first embodiment of the present technology, the pairs of phase difference detection pixels, which divide the exit pupil into left and right parts, are disposed in the imaging device. Hence, in the first embodiment of the present technology, the horizontal direction is set as the pupil division direction. In addition, the base regions and reference regions which are set by the region setting unit 261, will be described in detail in FIG. 7, and thus the description thereof is omitted herein.

The region setting unit 261 extracts the output values (pixel signal) of the pixels as base values among pairs of phase difference detection pixels disposed in the base region, from the output values of the phase difference detection pixels in the focus area supplied from the signal processing unit 240, and supplies the output values to the defocus amount calculation unit 263 and the abnormal value line detection unit 262. Further, the region setting unit 261 extracts the output values of the pixels as reference values among the pairs of phase difference detection pixels disposed in the reference region, from the output values of the phase difference detection pixels in the focus area, and supplies the output values to the defocus amount calculation unit 263 and the abnormal value line detection unit 262.

The abnormal value line detection unit 262 detects abnormal output values such that the output values (abnormal values) of pixels with abnormal values, which have an adverse effect on the accuracy in the phase difference detection (detection of misalignment between images), are not used in the phase difference detection. In addition, in the first embodiment of the present technology, the abnormal value line detection unit 262 calculates a value for detecting presence or absence of the abnormal value for each of the phase difference detection pixels (the phase difference detection pixels disposed at the same line) of which the positions are the same in the direction (orthogonal direction) orthogonal to the pupil division direction, and detects presence or absence of the abnormal value by using the values. That is, the abnormal value line detection unit 262 detects presence or absence of abnormality by using the value (line total) of each line, and identifies whether or not the phase difference detection pixel outputting the abnormal value is present for each line. In addition, in the embodiments of the present technology, a line, which includes the phase difference detection pixel outputting the abnormal value, is referred to as an abnormal value line. Further, in the first embodiment of the present technology, it is assumed that the row direction is the pupil division direction (refer to FIG. 4). Thus, the presence or absence of the abnormal value is detected on a row-by-row basis.

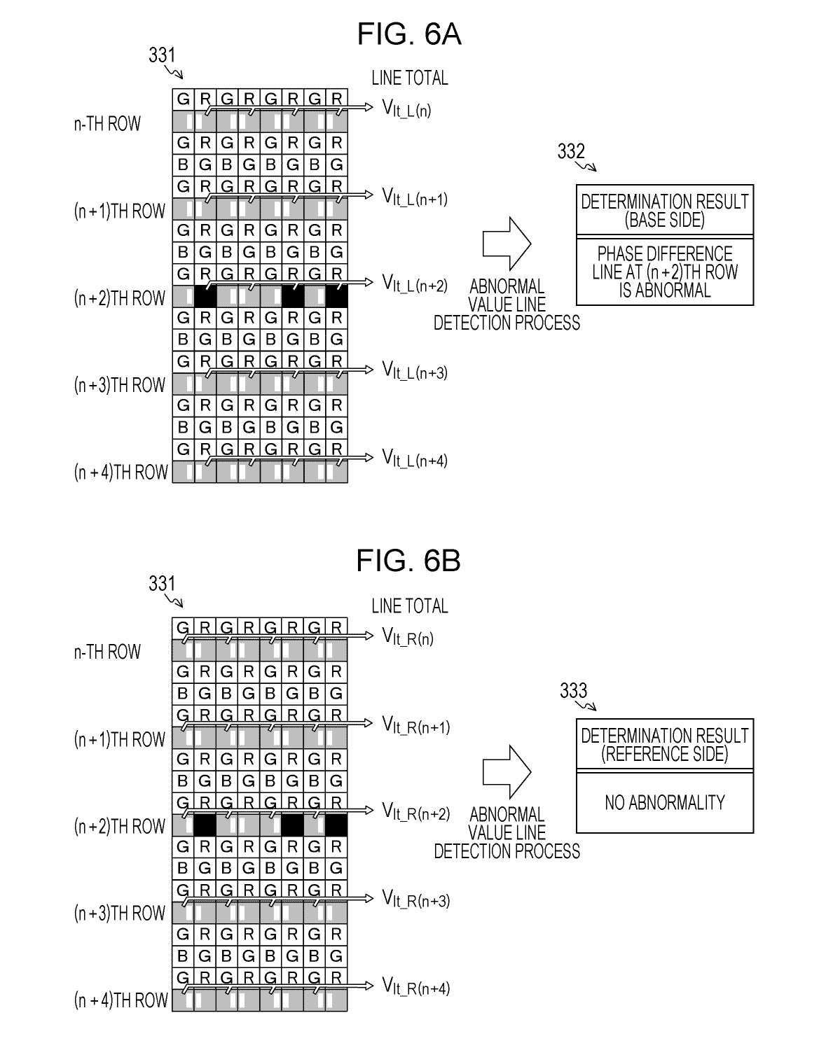

The abnormal value line detection unit 262 calculates a value (line total) through addition between the pixel signal of pixels disposed in the same line along the pupil division direction and the pixel signal of the phase difference detection pixels on the detection target side (base side or reference side) in the region (base region or reference region) of the abnormality detection target. Then, the abnormal value line detection unit 262 detects the line total of the abnormal values by comparing a plurality of line totals in the region of the detection target. In addition, a method of detecting the line total of the abnormal values will be described with reference to FIGS. 6A and 6B, and thus the description thereof is omitted herein. The abnormal value line detection unit 262 supplies the detection result (abnormal value line information) to the defocus amount calculation unit 263. It should be noted that the abnormal value line detection unit 262 is an example of the detection unit described in claims.

The defocus amount calculation unit 263 calculates a defocus amount by measuring (detecting the phase difference) the interval between the pair of images generated through the pupil division. The defocus amount calculation unit 263 calculates correlation between the reference region and the base region in which the abnormal values are not included, on the basis of the abnormal value line information of the reference region and the abnormal value line information of the base region supplied from the abnormal value line detection unit 262. That is, the defocus amount calculation unit 263 calculates the correlation excluding the output values of the phase difference detection pixels of the line which is indicated by the abnormal value line information supplied from the abnormal value line detection unit 262. In addition, a method of calculating the correlation is a general phase difference detection method, and thus the description will be omitted (for example, refer to Japanese Unexamined Patent Application Publication No. 2010-91991).

The defocus amount calculation unit 263 calculates the correlation with a plurality of reference regions set for a single base region, thereby detecting the reference region with highest correlation. Then, the defocus amount calculation unit 263 calculates the defocus amount, on the basis of a positional difference (a distance on the imaging surface) between the base region and the reference region with the highest correlation. Then, the defocus amount calculation unit 263 calculates the driving amount of the focus lens 213 on the basis of the calculated defocus amount, and supplies information, which indicates the driving amount, to the lens driving unit 270. It should be noted that the defocus amount calculation unit 263 is an example of the focusing determination unit described in claims.

The lens driving unit 270 drives the focus lens 213. The lens driving unit 270 moves the focus lens 213 on the basis of the driving amount of the focus lens supplied from the phase difference detection unit 260, thereby performing focusing. In addition, the lens driving unit 270 maintains the current position of the focus lens 213 when the focusing is appropriate (the driving amount of the focus lens 213 is “0”).

Next, the pixel arrangement in the imaging device 300 will be described with reference to FIG. 4.

### Example of Arrangement of Pixels in Imaging Device

FIG. 4 is a schematic diagram illustrating an example of arrangement of pixels provided in the imaging device 300 according to the first embodiment of the present technology.

In FIG. 4, description will be made assuming XY axes with the vertical direction as a Y axis, and the horizontal direction as an X axis. Further, it is assumed that a signal reading direction in this imaging device 300 is the X axis direction (the reading is performed on a row-by-row basis).

In FIG. 4, for convenience of description, the arrangement of pixels is described using a region (pixel region 310) of some pixels of the pixels disposed in the imaging device 300. It should be noted that the arrangement of pixels in the imaging device 300 is such arrangement as the pixel arrangement indicated in the pixel region 310 being repeated in the X axis direction and Y axis direction.

In FIG. 4, one pixel is indicated by one square. In addition, in FIG. 4, the image generation pixels are indicated by squares in which reference signs (R, G, and B) representing provided color filters are written. Specifically, the R pixel 311 indicates a pixel (R pixel) which receives red light using a color filter transmitting red (R) light, and the G pixel 312 indicates a pixel (G pixel) which receives green light using a color filter transmitting green (G) light. In addition, the B pixel 313 indicates a pixel (B pixel) which receives blue light using a color filter transmitting blue (B) light.

Further, the phase difference detection pixels are indicated by gray squares appended with white rectangles. It should be noted that the white rectangle in the phase difference detection pixel indicates a side where incident light is received by a light receiving element (side not covered with a light-blocking layer for performing pupil division).

Here, the phase difference detection pixels (right opening phase difference detection pixel 315, left opening phase difference detection pixel 316) shown in FIG. 4 will be described.

The right opening phase difference detection pixel 315 is a phase difference detection pixel where a light-blocking layer is formed so as to block the subject light transmitted through the right side of the exit pupil of subject light to be input to a micro lens of the right opening phase difference detection pixel 315. That is to say, the right opening phase difference detection pixel 315 blocks the right-side (plus side of the X axis direction) light of light pupil-divided into the left and right (plus and minus sides in the X axis direction) of the exit pupil, and receives the left-side (minus side of the X axis direction) pupil-divided rays.

The left opening phase difference detection pixel 316 is a phase difference detection pixel wherein a light-blocking layer is formed so as to block the subject light transmitted through the left side of the exit pupil of subject light to be input to a micro lens of the left opening phase difference detection pixel 316. That is to say, this left opening phase difference detection pixel 316 blocks the left-side (minus side of the X axis direction) light of light pupil-divided into the left and right (plus and minus sides in the X axis direction) of the exit pupil, and receives the right-side (plus side of the X axis direction) pupil-divided rays. Further, the left opening phase difference detection pixel 316 is employed as a pair with the right opening phase difference detection pixel 315, thereby forming a pair of images.

Here, the arrangement of the pixels in the imaging device 300 will be described.

As shown in the pixel region 310, the pixels of the imaging device 300 are arranged in rows (lines), in which only the image generation pixels are disposed, and rows (lines) in which only the phase difference detection pixels are disposed. The rows (hereinafter referred to as the phase difference lines) of only the phase difference detection pixels are disposed with predetermined intervals in a direction (column direction) orthogonal to the reading direction (row direction) (at every fourth row in FIG. 4), and the rows of only the image generation pixels are disposed at the other rows. It should be noted that, in the phase difference line, the left opening phase difference detection pixels 316 and the right opening phase difference detection pixels 315 are alternately disposed in the X axis direction. Further, at the rows of only the image generation pixels, the image generation pixels are disposed such that the color filters are arranged in the Bayer pattern.

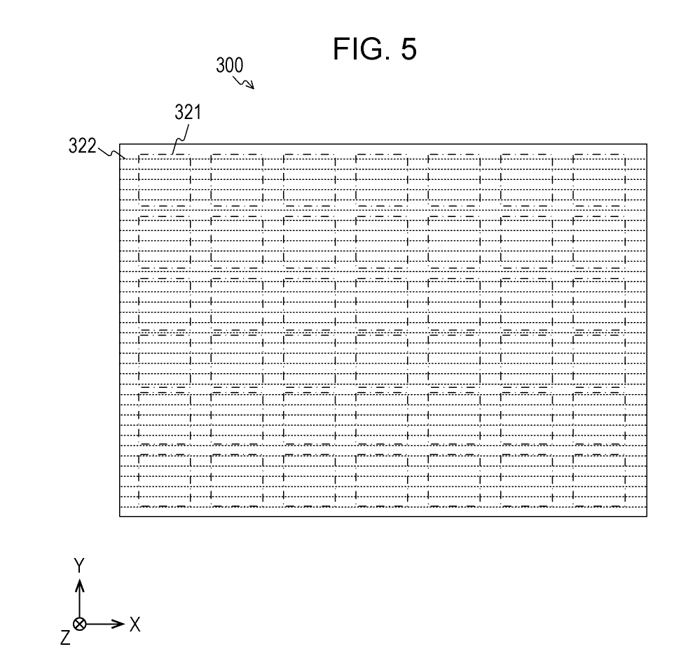

Next, the focus area, which is set in the imaging device 300, will be described with reference to FIG. 5.

### Example of Focus Area in Imaging Device

FIG. 5 is a diagram schematically illustrating the focus area which is set in the imaging device 300 according to the first embodiment of the present technology.

FIG. 5 shows dashed lines (phase difference lines 322), which indicate the phase difference lines, and chain-line rectangles (focus areas 321), which indicate the preset focus areas, in the imaging device 300. It should be noted that the number of the phase difference lines 322, the number of focus areas 321, and the positional relationship therebetween are briefly illustrated for convenience of description.

As shown in FIG. 5, a plurality of preset focus areas 321 as candidates for the focus area to perform the phase difference detection is set in the imaging device 300. Thus, the focus area 321, at the position where an image of the focusing target object is captured, is selected as the focus area to perform the phase difference detection. It should be noted that, since the plurality of phase difference lines 322 is disposed in the focus area 321, it is possible to improve the accuracy of the phase difference detection by performing the phase difference detection using the plurality of phase difference lines.

Subsequently, the abnormality detection, which is performed on a row-by-row basis by the abnormal value line detection unit 262, will be described with reference to FIGS. 6A and 6B.

### Example of Abnormality Detection on Row-By-Row Basis

FIGS. 6A and 6B are diagrams schematically illustrating examples of abnormality detection which is performed on a row-by-row basis by an abnormal value line detection unit 262 in the first embodiment of the present technology.

FIG. 6A shows abnormality detection in a case of setting a predetermined pixel region as the base region. FIG. 6B shows abnormality detection in a case of setting the pixel region, which is the same as that of FIG. 6A, as the reference region. In addition, in and after FIGS. 6A and 6B, description will be given assuming that the output values (pixel values) of the left opening phase difference detection pixels among the pairs of phase difference detection pixels are set as base values, and the output values of the right opening phase difference detection pixels are set as reference values.

FIG. 6A shows a region (pixel region 331) of pixels arranged in 18 rows×8 columns in which the row (phase difference lines) of only the phase difference detection pixels is arranged on every fourth row. FIG. 6A also shows a table (table 332) which indicates the result of the abnormality detection in the case of setting the pixel region 331 as the base region. In the pixel region shown in FIG. 6A, five rows of the phase difference lines (phase difference lines at the n-th to (n+4)th rows) are disposed. In addition, it is assumed that, in the pixel region 331, among the left opening phase difference detection pixels at the (n+2)th row, defective (black defect) pixels with constantly low output values are present. Accordingly, the phase difference detection pixels with the black defects are indicated by black rectangles.

Here, a description will be given of detection of abnormal values in the case of setting the pixel region 331 as the base region. When the pixel region 331 is set as the base region at the time of phase difference detection, the region setting unit 261 supplies the output values, which are output by the phase difference detection pixels on the base side (left opening side) among the output values of the phase difference detection pixels in the pixel region 331, as the output values of the base region, to the abnormal value line detection unit 262 and the defocus amount calculation unit 263.

The abnormal value line detection unit 262 detects whether or not the abnormal output value (abnormal value) is present when the output values in the base region are supplied. The abnormal value line detection unit 262, first, calculates a value as a line total for every phase difference line of the base region. The line total is obtained by adding the output values of the left opening phase difference detection pixels disposed at the same line (at the same row in the pixel region 331).

When the line totals (Vₗₜ_{_{—}}_{L(n)} to Vₗₜ_{_{—}}_{L(n+4)}) of all the lines (rows in the pixel region 331) in the pixel region 331 are calculated, the abnormal value line detection unit 262 checks (detects an abnormal value) whether or not a plurality of the calculated line totals includes an abnormal line total.

For example, when there is a line total satisfying the following Expressions 1 and 2, the abnormal value line detection unit 262 determines the line total as an abnormal value.

$$\begin{matrix}\frac{( {\sum }_{i = 1}^{m} {V}_{lt\_L ( i )} ) - {V}_{lt\_L ( min )}}{m - 1} > {V}_{lt\_L ( min )} \times C & Expression 1 \\ \frac{( {\sum }_{i = 1}^{m} {V}_{lt\_L ( i )} ) - {V}_{lt\_L ( max )}}{m - 1} > {V}_{lt\_L ( max )} \div C & Expression 2\end{matrix}$$

Here, Vₗₜ_{_{—}}_{L(min)} is a (min) line total with the lowest value among the calculated line totals (Vₗₜ_{_{—}}_{L(n)} to Vₗₜ_{_{—}}_{L(n+4)}). Further, Vₗₜ_{_{—}}_{L(max)} is a (max) line total with the highest value among the calculated line totals. Furthermore, m is a total number of the calculated line totals (“5” in the pixel region 331). In addition, C is a constant for setting the limit (threshold value) which is for determination as to whether the line total (Vₗₜ_{_{—}}_{L(min)} or Vₗₜ_{_{—}}_{L(max)}) subjected to the abnormal value determination is an abnormal value or a normal value. Here, regarding the constant C, it is assumed that, for example, “2” is set as the constant C.

Hereinafter, the above-mentioned Expression 1 will be described. The left-hand side of the above-mentioned Expression 1 represents an average (hereinafter referred to as a regional average) of the line totals excluding the line total Vₗₜ_{_{—}}_{L(min)} with the lowest value subjected to the determination. That is, when the constant C is “2” a value, which is set as twice the line total Vₗₜ_{_{—}}₍ₘᵢₙ₎ with the lowest value, may be less than the regional average. In this case, it is determined that the line total Vₗₜ_{_{—}}₍ₘᵢₙ₎ with the lowest value is an abnormal value, on the basis of the above-mentioned Expression 1. Specifically, on the basis of the above-mentioned Expression 1, it is possible to detect a line, in which a phase difference detection pixel (for example, a pixel to which a foreign particle is attached or which has a black defect) with a significantly low output is disposed, as the abnormal value line.

Subsequently, the above-mentioned Expression 2 will be described. The left-hand side of the above-mentioned Expression 2 represents an average of the line totals excluding the line total Vₗₜ_{_{—}}_{L(max)} with the highest value subjected to the determination, and indicates a regional average in a similar manner to the left-hand side of the above-mentioned Expression 1. When the constant C is “2” in Expression 2 mentioned above, a value, which is set as a half of the line total Vₗₜ_{_{—}}_{L(max)} with the highest value, may be greater than the regional average. In this case, it is determined that the line total Vₗₜ_{_{—}}_{L(max)} is an abnormal value, on the basis of the above-mentioned Expression 2. Specifically, on the basis of the above-mentioned Expression 2, it is possible to detect a line, in which a phase difference detection pixel (for example, a pixel which has a white defect) with a significantly high output is disposed, as the abnormal value line.

Here, a description will be given of a reason why the line totals with abnormal values can be detected on the basis of the above-mentioned Expressions 1 and 2. The n-th to (n+4)th rows of the phase difference lines are disposed with intervals of four pixels in the direction (column direction) orthogonal to the pupil division direction. Thus, the positions of the rows in the imaging device are relatively close. In addition, between the phase difference detection pixels which are disposed at different rows but with a close distance and are disposed at the same column, the output values thereof are relatively approximate to each other. That is, the values (line totals), which are obtained by adding the output values on a line-by-line basis (row-by-row basis), are also approximate to each other if the positions (positions in the column direction) between the lines are close. Hence, by detecting the line total, which is significantly different from the average (regional average) of the line totals other than the determination target in the base region, on the basis of the above-mentioned Expressions 1 and 2, it is possible to detect the line total with an abnormal value.

Here, regarding the line totals of the pixel region 331 of FIG. 6A, it is assumed that Vₗₜ_{_{—}}_{L(n)} is “100”, Vₗₜ_{_{—}}_{L(n+1)} is “102”, Vₗₜ_{_{—}}_{L(n+2)} is “25”, Vₗₜ_{_{—}}_{L(n+3)} is “100”, and Vₗₜ_{_{—}}_{L(n+4)} is “103”. Under these assumptions, the calculation results of the above-mentioned Expressions 1 and 2 will be described.

Under the assumption of the values, the line total Vₗₜ_{_{—}}_{L(min)} with the lowest value of the above-mentioned Expression 1 is Vₗₜ_{_{—}}_{L(n+2)} with a value of “25”. In addition, the left-hand side (regional average) of the above-mentioned Expression 1 is “101.25” which is an average of the line totals other than Vₗₜ_{_{—}}_{L(n+2)}. Further, the right-hand side of the above-mentioned Expression 1 is “50” which is twice the value of Vₗₜ_{_{—}}_{L(n+2)}. That is, since the above-mentioned Expression 1 is satisfied, it is determined that Vₗₜ_{_{—}}_{L(n+2)} is an abnormal value, and it is determined that the phase difference line at the (n+2)th row is an abnormal value line.

Further, under the assumption of the values, the line total Vₗₜ_{_{—}}_{L(max)} with the highest value of the above-mentioned Expression 2 is Vₗₜ_{_{—}}_{L(n+4)} with a value of “103”. The left-hand side (regional average) of the above-mentioned Expression 2 is “81.75”, and the right-hand side of the above-mentioned Expression 2 is “56.5”. That is, since the above-mentioned Expression 2 is not satisfied, it is determined that Vₗₜ_{_{—}}_{L(n+4)} is a normal value, and it is determined that the phase difference line at the (n+4)th row is not abnormal.

As described above, by performing the abnormality detection on the basis of the above-mentioned Expressions 1 and 2, as shown in the table 332, the phase difference line at the (n+2)th row is detected as an abnormal value line. In addition, the detection of the abnormal value line shown in FIG. 6A is an exemplary case where the pixel region 331 is set as the base region and the abnormal value line is detected by using the output values of the left opening phase difference detection pixels on the base side. When the pixel region 331 is set as the reference region, the abnormality detection is performed on the basis of the output values which are output by the phase difference detection pixels on the reference side (right opening side), and thus the detection result of the abnormal value line becomes different. Next, the detection result of the abnormal value line in the case of setting the pixel region 331 of FIG. 6A as the reference region will be described with reference to FIG. 6B.

FIG. 6B shows the pixel region 331 of FIG. 6A and a table (table 332) which indicates the result of the abnormality detection in the case of setting the pixel region 331 as the reference region.

In addition, a method of performing detection in different vertical and horizontal directions is the same as that of FIG. 6A except that the calculation is performed using the output values, which are output by the phase difference detection pixels on the reference side (right opening side), and the detailed description thereof will be omitted herein.

That is, when the pixel region 331 is set as the reference region at the time of phase difference detection, the region setting unit 261 supplies the output values, which are output by the phase difference detection pixels on the reference side (right opening side) in the pixel region 331, as the output values of the reference region, to the abnormal value line detection unit 262 and the defocus amount calculation unit 263. In addition, in the abnormal value line detection unit 262, the output values of the right opening phase difference detection pixels are added, and the line totals (Vₗₜ_{_{—}}_{R(n)} to Vₗₜ_{_{—}}_{R(n+4)}) are calculated, thereby detecting abnormality on the basis of the line totals.

In addition, the abnormality detection method is the same as the example of the base region shown in FIG. 6A. That is, the abnormality of the reference region is calculated using Numerical Expressions (which are not shown since L of Expressions 1 and 2 is simply substituted by R) in which the above-mentioned Expressions 1 and 2 are represented by the line total (Vₗₜ_{_{—}}_{R}) on the right opening side (R) instead of the line total (Vₗₜ_{_{—}}_{L}) on the left opening side (L). In addition, no pixel, which outputs the abnormal value, is included in the right opening phase difference detection pixels of the pixel region 331, and thus there is no line total satisfying the above-mentioned Expressions 1 and 2. Hence, as shown in the table 333, it is detected that there is no abnormal value line in the reference region.

As shown in FIGS. 6A and 6B, the abnormal value line detection unit 262 detects abnormality for each region (the base region or the reference region) on a line-by-line basis by using the value (line total) which is obtained by totaling the output values on a line-by-line basis. In addition, by detecting the abnormality on a line-by-line basis, it is possible to make a period of time, which is necessary for determination of the abnormal value, shorter than when the abnormality is detected through comparison on a pixel-by-pixel basis.

The abnormality detection result (abnormal value line information) obtained by the abnormal value line detection unit 262 is supplied to the defocus amount calculation unit 263. Then, in the defocus amount calculation unit 263, the output values of the phase difference detection pixels at the abnormal line are caused not to be used, whereby the correlation is calculated between the base side of the base region and the reference side of the reference region.

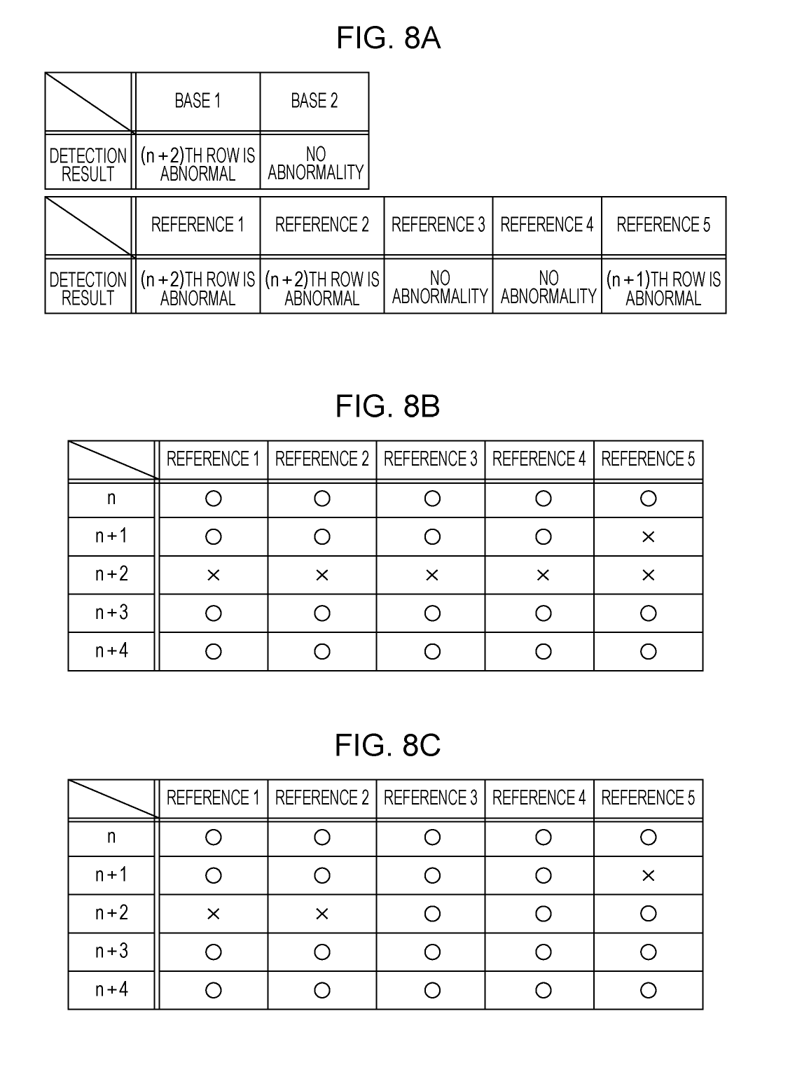

Next, an example of the correlation calculation excluding the abnormal value line, will be described with reference to FIGS. 7 and 8A to 8C.

Example of Correlation Calculation in which Abnormal Value Line is Excluded

FIGS. 7 and 8A to 8C are schematic diagrams illustrating relationships between the abnormal value lines, which are detected by the abnormal value line detection unit 262, and correlation calculation, which is performed by the defocus amount calculation unit 263, in the first embodiment of the present technology.

FIG. 7 shows a partial region (pixel region 340) of the focus area subjected to the focusing determination in order to describe the correlation calculation excluding the abnormal value lines in FIGS. 8A to 8C. In addition, in FIG. 7, the ranges of two base regions (bases 1 and 2) and five reference regions (references 1 to 5) in the pupil division direction are indicated by the double-sided arrows.

As indicated by the bases 1 and 2 and the references 1 to 5, in FIGS. 7 and 8A to 8C, the region of the pixels of 8 rows×18 columns is designated as the base region or the reference region. That is, in FIGS. 7 and 8A to 8C, the correlation is calculated using the phase difference lines of five rows, and the defocus amount is calculated using the calculated correlation.

In addition, in the description of FIGS. 7 and 8A to 8C, it is assumed that two foreign particles (foreign particles 351 and 352) are attached to the pixel region 340. In FIGS. 7 and 8A to 8C, the pixels (pixels covered with the foreign particles 351 and 352 in FIG. 7), which are unable to receive light due to the foreign particles 351 and 352, generate output signals with abnormal values.

The foreign particle 351 is attached at a position (4th to 7th columns from the left end of the pixel region 340 in the phase difference line at the (n+2)th row) around the phase difference line at the (n+2)th row at the columns included in the base 1 and the references 1 and 2. Further, the foreign particle 352 is attached at a position (at 22nd to 24th rows from the left end of the pixel region 340 in the phase difference line at the (n+1)th row) around the phase difference line at the (n+1)th row at the column at which only the reference 5 is set.

In FIGS. 8A to 8C, FIG. 8A shows a table of results of the abnormality detection of the regions, FIG. 8B shows a table of rows used in the calculation of correlation between the base 1 and the reference regions, and FIG. 8C shows a table of rows used in the calculation of correlation between the base 2 and the reference regions.

As shown in FIG. 8A, when the abnormal value line detection unit 262 performs abnormality detection on the regions, in the base regions, it is detected that the (n+2)th row is abnormal in the base 1, and it is detected that there is no abnormal line in the base 2. Further, in the reference regions, it is detected that the (n+2)th row is abnormal in the references 1 and 2, it is detected that there is no abnormal line in the references 3 and 4, and it is detected that the (n+1)th row is abnormal in the reference 5.

When the results (abnormal value line information) of the abnormality detection shown in FIG. 8A are supplied from the abnormal value line detection unit 262 to the defocus amount calculation unit 263, the defocus amount calculation unit 263 performs correlation calculation excluding the output values of the phase difference detection pixels of the line determined to be abnormal. That is, the defocus amount calculation unit 263 performs correlation calculation without using the line including the phase difference detection pixels, which output the abnormal output values by which it is determined that the line total is abnormal, in the correlation calculation.

Next, a description will be given of the correlation calculation in the case of detecting abnormality as shown in FIG. 8A. In addition, in the descriptions of FIGS. 8A to 8C, for convenience of description, it is assumed that the correlations between the two base regions (bases 1 and 2) and the reference regions are calculated. First, the correlation calculation between the base 1 and the reference regions will be described.

In the table shown in FIG. 8B, the rows used in the correlation calculation between the base 1 and the reference regions are indicated by “O”, and the unused rows are indicated by “X”.

In the base 1, it is determined that the line total of the (n+2)th row is abnormal. Hence, in the correlation calculation between the reference regions (references 1 to 5), the output values of the phase difference detection pixels at the (n+2)th row are not used. In addition, in the reference 5, it is determined that the (n+1)th row is abnormal. Hence, in the correlation calculation between the base 1 and the reference 5, the output values of the phase difference detection pixels at the (n+1)th row are not used. Further, in the references 1 and 2, it is also determined that the line total of the (n+2)th row is abnormal, but the line total is equal to that of the row ((n+2)th row) of the abnormal value line of the base 1. Hence, there is no increase in the number of rows of which the output values are not used in the correlation calculation.

As described above, when the correlation calculation is performed, as shown in FIG. 8B, in the correlation calculation between the base 1 and the references 1 to 4, the output values of the phase difference detection pixels at the n-th, (n+1)th, (n+3)th, and (n+4)th rows are used. Further, in the correlation calculation between the base 1 and the reference 5, the output values of the phase difference detection pixels at the n-th, (n+3)th, and (n+4)th rows are used.

Next, the correlation calculation between the base 2 and the reference regions will be described with reference to FIG. 8C.

In the table shown in FIG. 8C, the rows used in the correlation calculation between the base 2 and the reference regions are indicated by “O”, and the unused rows are indicated by “X”.

In the base 2, it is determined that all the phase difference lines are normal. Hence, when there is no abnormal line in the reference region, the correlation calculation is performed using all the phase difference lines. When there is an abnormal line in the reference region, the correlation calculation is performed excluding the output values of the phase difference detection pixels at the abnormal line.

Since it is determined that the (n+2)th row is abnormal in the references 1 and 2, in the correlation calculation with the base 2, the output values of the phase difference detection pixels at the n-th, (n+1)th, (n+2)th, (n+3)th, and (n+4)th rows are used. Further, since there is no abnormal line in the references 3 and 4, in the correlation calculation with the base 2, the output values of the phase difference detection pixels of all the phase difference lines (the n-th, (n+1)th, (n+3)th, and (n+4)th rows) are used. In addition, since it is determined that the (n+1)th row is abnormal in the reference 5, in the correlation calculation with the base 2, the output values of the phase difference detection pixels at the n-th, (n+2)th, (n+3)th, and (n+4)th rows are used.

As described above, the phase difference detection unit 260 detects the phase difference line including the phase difference detection pixel with the abnormal output value, and performs the correlation calculation without using the detected phase difference line.

In addition, in the description of the example shown in FIGS. 6A to 8C, the line total is calculated from the output values of the left opening phase difference detection pixels in the base region, and the line total is calculated from the output values of the right opening phase difference detection pixels in the reference region. However, the present technology is not limited to this. For example, the line total may be calculated by adding both output values of the left opening phase difference detection pixel and the right opening phase difference detection pixel, and the base region and the reference region do not have to be separated in calculation of the abnormal value line. Further, in the description of the example, the value, which is obtained by simple addition, is set as the line total, but the present technology is not limited to this. For example, an average thereof may be calculated therefor.

### Operation Example of Imaging Apparatus

Next, the operation of the imaging apparatus 100 according to the first embodiment of the present technology will be described with reference to the drawings.

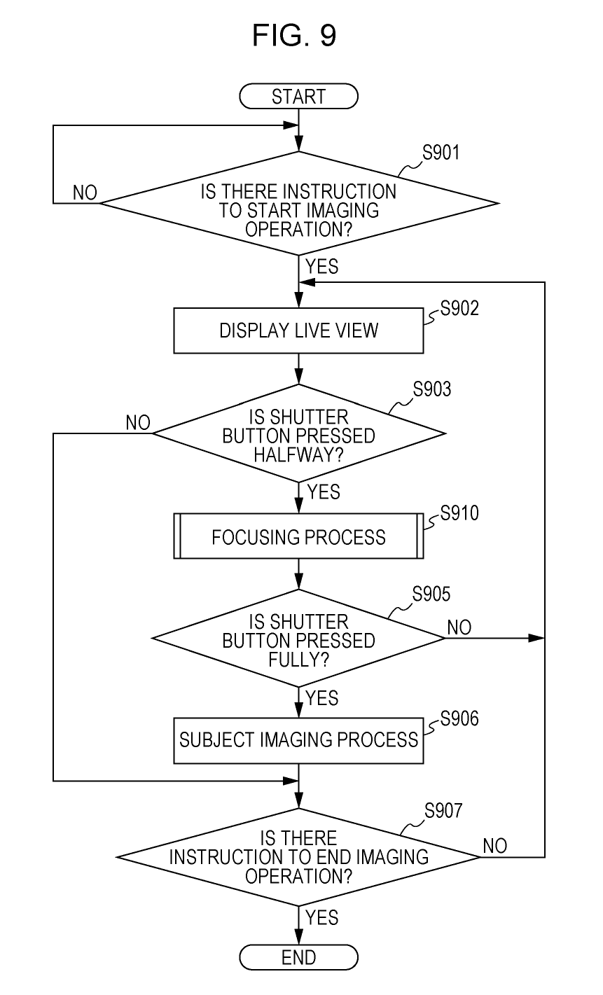

FIG. 9 is a flowchart illustrating an example of an imaging processing procedure of the imaging apparatus 100 according to the first embodiment of the present technology.

First, the control unit 230 determines whether or not there is an instruction to start the imaging operation (for example, setting an operation mode of the imaging apparatus 100 as a mode of capturing a still image) (step S901). If it is determined that there is no instruction to start the imaging operation, the control unit 230 remains on standby until there is an instruction to start the imaging operation.

In contrast, if the control unit 230 determines that there is the instruction to start the imaging operation (step S901), a live-view image is displayed on the display unit 281 (step S902). Subsequently, the control unit 230 determines whether or not the shutter button has been pressed halfway (step S903). Then, if it is determined that the shutter button has not been pressed halfway (step S903), the procedure advances to step S907.

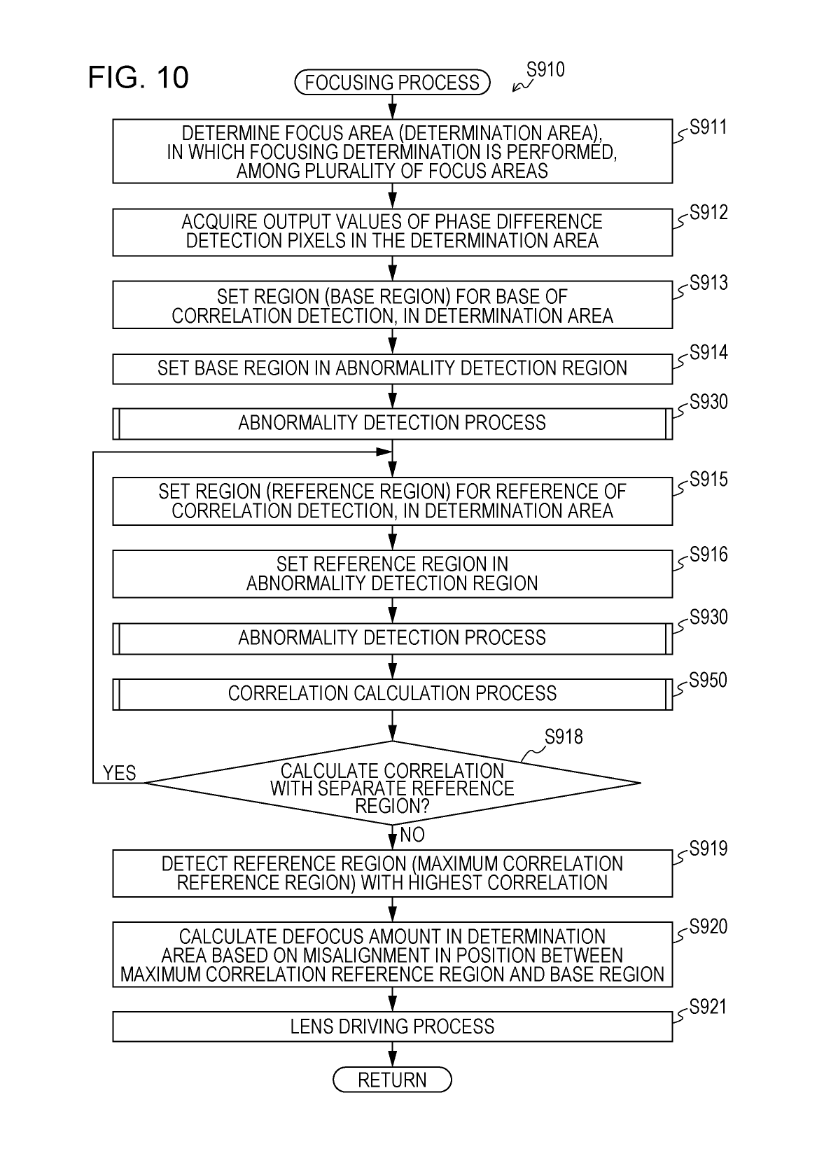

In addition, if it is determined that the shutter button has been pressed halfway (step S903), a focusing process, in which focusing is performed on the basis of the result of the focusing determination based on the phase difference detection, is performed (step S910). It should be noted that the focusing process (step S910) will be described with reference to FIG. 10, and thus the description thereof is omitted herein.

In addition, if the control unit 230 determines whether or not the shutter button has been pressed fully (step S905) and determines that the shutter button has not been pressed fully (has been pressed halfway), the procedure returns to step S902.

In contrast, if it is determined that the shutter button has been pressed fully (step S905), a process (subject imaging process) of capturing an image of a subject and recording the image as a still image is performed (step S906).

Thereafter, the control unit 230 determines whether or not there is an instruction to end the imaging operation (for example, an instruction to set the operation mode of the imaging apparatus 100 to a mode of reproducing the image which is recorded in the mode of capturing the still image) (step S907). Then, if it is determined that there is no instruction to end the imaging operation (step S907), the procedure returns to step S902.

In contrast, if it is determined that there is the instruction to end the imaging operation (step S907), the imaging operation ends.

FIG. 10 is a flowchart illustrating an example of a procedure of a focusing process (step S910) in the imaging processing procedure according to the first embodiment of the present technology.

First, among a plurality of preset focus areas, a focus area (determination area), in which an image of a focusing target object is captured and the focusing determination is performed, is determined (step S911). Subsequently, the output values of the phase difference detection pixels in the determination area are acquired by the region setting unit 261 of the phase difference detection unit 260 (step S912). Thereafter, the region setting unit 261 sets the region (base region) as a base of the correlation calculation in the determination area (step S913). It should be noted that step S912 is an example of the acquisition step described in claims.

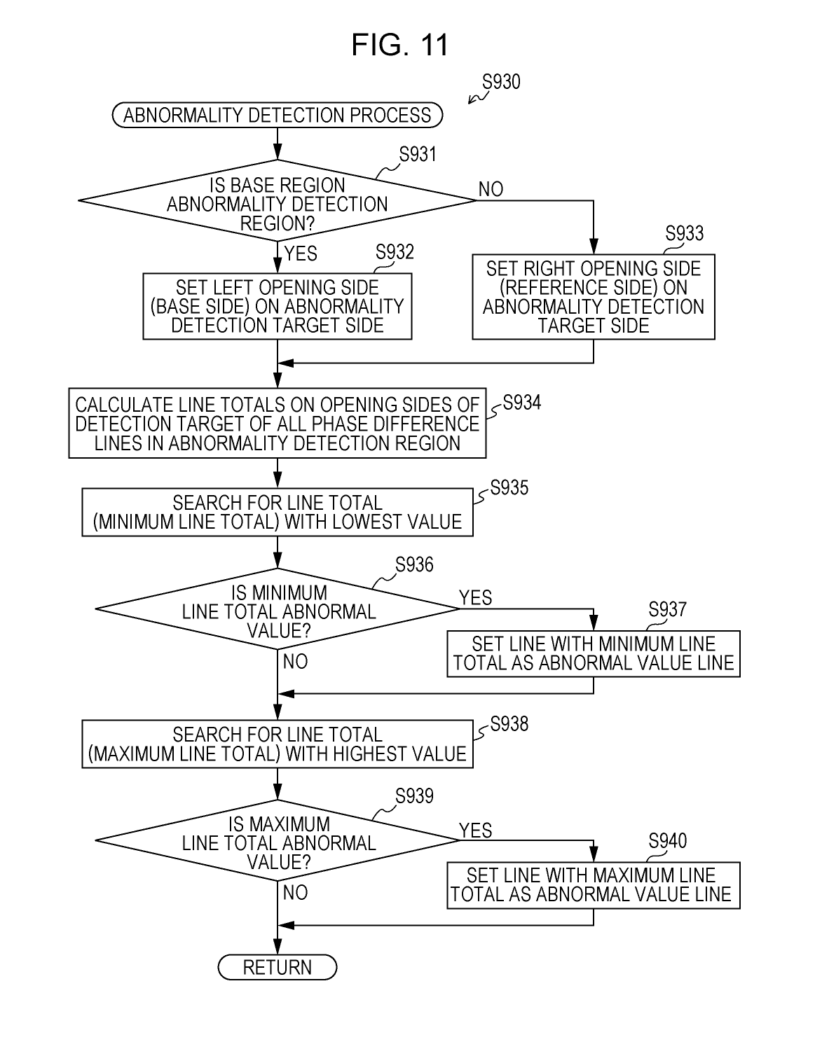

Subsequently, the output values of the phase difference detection pixels on the base side (left opening side) in the base region are supplied to the abnormal value line detection unit 262, and in the abnormal value line detection unit 262, a base region is set in the region (abnormality detection region) for detecting the abnormal value line (step S914). Then, the abnormal value line detection unit 262 performs a process (abnormality detection process) of detecting the abnormal value line in the abnormality detection region (step S930). It should be noted that the abnormality detection process (step S930) will be described with reference to FIG. 11, and thus the description thereof is omitted herein. It should be noted that step S930 is an example of the detection step described in claims.

Next, in the determination area, a region (reference region) as a reference of correlation calculation is set by the region setting unit 261 (step S915). Subsequently, the output values of the phase difference detection pixels on the reference side (right opening side) in the reference region are supplied to the abnormal value line detection unit 262, and in the abnormal value line detection unit 262, the reference region is set in the region (abnormality detection region) for detecting the abnormal value line (step S916). Then, the abnormal value line detection unit 262 performs the process (abnormality detection process) of detecting the abnormal value line in the abnormality detection region (step S930).

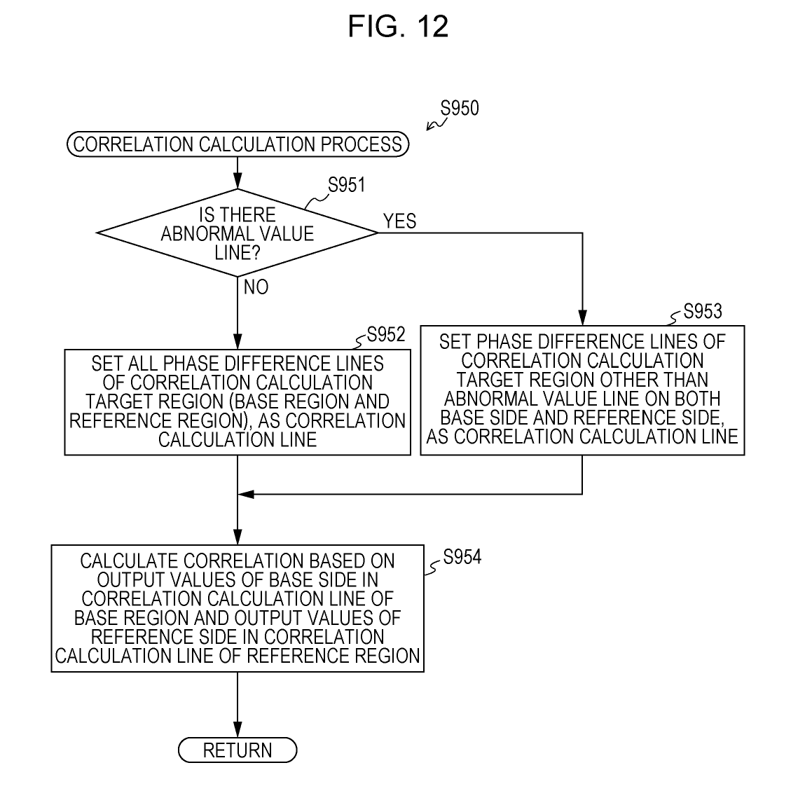

Subsequently, the defocus amount calculation unit 263 performs a process (correlation calculation process) of calculating the correlation between the output values on the base side in the base region and the output values on the reference side in the reference region in a state where the abnormal value line is excluded (step S950). It should be noted that the correlation calculation process (step S950) will be described with reference to FIG. 12, and thus the description thereof is omitted herein.

Thereafter, the region setting unit 261 determines whether or not to calculate the correlation between the base region and a separate reference region having different positions in the phase difference direction (step S918). If it is determined to perform the calculation, the procedure returns to step S915.

In contrast, if it is determined not to calculate the correlation with the separate reference region (step S918), the defocus amount calculation unit 263 detects the reference region (maximum correlation reference region) with the highest correlation to the base region (step S919). Then, on the basis of the positional deviation between the base region and the detected maximum correlation reference region, the defocus amount calculation unit 263 calculates a defocus amount in the determination area (step S920). Subsequently, a process (lens driving process) of driving the focus lens is performed on the basis of the calculated defocus amount (step S921), and the focusing process (step S910) ends. It should be noted that steps S919, S920, and, S950 are examples of the focusing determination step described in claims.

FIG. 11 is a flowchart illustrating an example of a procedure of an abnormality detection process (step S930) in the imaging processing procedure according to the first embodiment of the present technology.

It should be noted that the abnormal value line detection unit 262 performs respective steps of the procedure of the abnormality detection process (step S930).

First, it is determined whether or not the region (abnormality detection region) designated as a target to be subjected to the abnormality detection process is the base region (step S931). Then, if the designated region is the base region (step S931), the phase difference detection pixels on the left opening side (base side) are set to the abnormality detection target side (step S932), and the procedure advances to step S934.

In contrast, if the designated region is not the base region (if it is the reference region) (step S931), the phase difference detection pixels on the right opening side (reference side) are set to the abnormality detection target side (step S933). Subsequently, the line totals of the respective phase difference lines are calculated on the basis of the output values of the phase difference detection pixels, of which the opening side is the detection target side, in all the phase difference lines in the abnormality detection region (step S934).

Then, among the line totals of all the calculated phase difference lines, the line total (minimum line total) with the lowest value is searched for (step S935). Next, by comparing the minimum line total with the other line totals (for example, in Expression 1 in FIGS. 6A and 6B), it is determined (abnormal value determination) whether or not the minimum line total is an abnormal value (step S936). Then, if it is determined that the minimum line total is an abnormal value (step S936), the line with the minimum line total is set as a line (abnormal value line) which includes a phase difference detection pixel outputting an abnormal output value (step S937), and the procedure advances to step S938.

In contrast, if it is determined that the minimum line total is not an abnormal value (step S936), among the line totals of all the calculated phase difference lines, the line total (maximum line total) with the highest value is searched for (step S938). Next, by comparing the maximum line total with the other line totals (for example, in Expression 2 in FIGS. 6A and 6B), it is determined (abnormal value determination) whether or not the maximum line total is an abnormal value (step S939). Then, if it is determined that the maximum line total is an abnormal value (step S939), the line with the maximum line total is set as an abnormal value line (step S940), and the procedure of the abnormality detection process (step S930) ends. Further, also if it is determined that the maximum line total is not an abnormal value (step S939), the procedure of the abnormality detection process (step S930) ends.

FIG. 12 is a flowchart illustrating an example of a procedure of a correlation calculation process (step S950) in the imaging processing procedure according to the first embodiment of the present technology.

In addition, the defocus amount calculation unit 263 performs respective steps of the procedure of the correlation calculation process (step S950).

First, it is determined whether or not an abnormal value line is included in the phase difference lines in the correlation calculation target regions (base region and reference region) subjected to the correlation calculation, on the basis of the abnormal value line information supplied from the abnormal value line detection unit 262 (step S951). Then, if it is determined that no abnormal value line is included (step S951), all the phase difference lines in the correlation calculation target regions are set as the correlation calculation lines (step S952), and the procedure advances to step S954.

In contrast, if it is determined that the abnormal value line is included (step S951), the phase difference lines of the correlation calculation target regions other than the abnormal value line on both the base side and the reference side are set as the correlation calculation lines (step S953).

Subsequently, on the basis of the output values on the base side in the correlation calculation lines in the base region and the output values on the reference side in the correlation calculation lines in the reference region, the correlation between the base region and the reference region is calculated (step S954), and the procedure of the correlation calculation process ends.

It should be noted that the procedures shown in FIGS. 9 to 11 are just examples. For example, FIG. 10 shows an example of calculation of the defocus amount on the basis of the deviation which is detected using the single base region. However, the present technology is not limited to this, and the average of the deviations, which are detected using the plurality of base regions, may be set as the defocus amount. Further, FIG. 11 shows an example in which the determination as to abnormality of a low pixel value is made (steps S935 to S937) and subsequently the determination as to abnormality of a high pixel value is made (steps S938 to S940). However, the order of the determination operations may be reversed, and the determination operations may be performed at the same time.

As described above, according to the first embodiment of the present technology, by performing the correlation calculation excluding the line including a phase difference detection pixel outputting an abnormal value, it is possible to improve the accuracy of the phase difference detection in the region which includes the phase difference detection pixel generating the abnormal value.

### 2. Second Embodiment

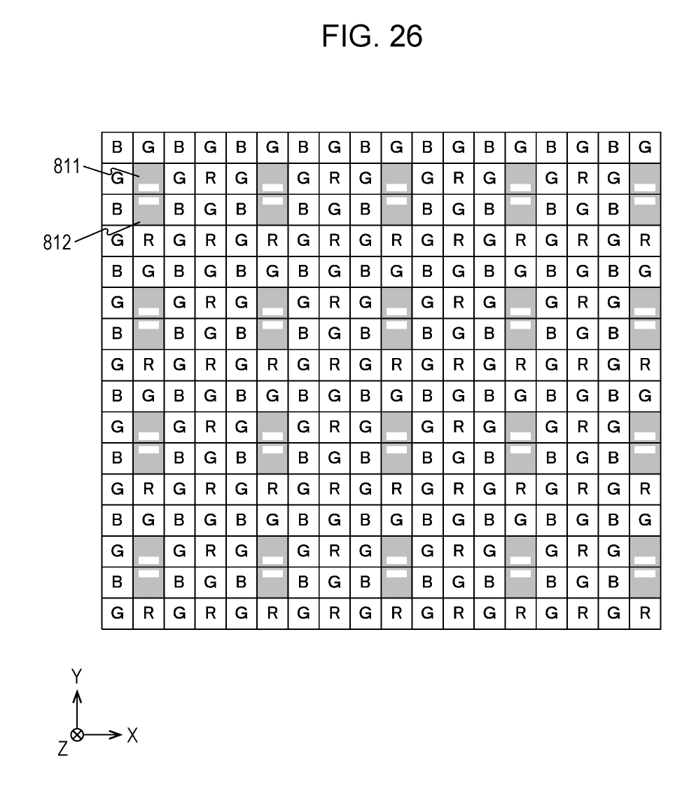

In the description of the first embodiment of the present technology, it is assumed that only the phase difference detection pixels (the left opening phase difference detection pixels and the right opening phase difference detection pixels), which are simply pupil-divided into left and right, are disposed as the phase difference detection pixels in the imaging device. It should be noted that the arrangement in the imaging device is not limited to this. For example, it is conceivable that the phase difference detection pixels, which are pupil-divided into upper and lower, are disposed, and it is also conceivable that both the phase difference detection pixels, which are pupil-divided into left and right, and the phase difference detection pixels, which are pupil-divided into upper and lower, are disposed. The example of the arrangement of the phase difference detection pixels different from that in the first embodiment of the present technology will be described as a modified example with reference to FIGS. 26 to 28.

In addition, in the description of the first embodiment of the present technology, the positions (hereinafter referred to as exit pupil positions) of the exit pupils of lenses of the imaging apparatus in the optical axis direction are not particularly considered. In the first embodiment of the present technology, the exit pupil at a predetermined exit pupil position is divided into two equal parts through the pupil division, and each phase difference detection pixel is designed so as to receive light through one of each pair of divided pupils. In addition, when the exit pupil position is changed, the distance between the exit pupil and the imaging device is changed. Hence, in a camera (for example, single-lens reflex camera) with interchangeable lenses, a plurality of types of the phase difference detection pixels with appropriate different exit pupil positions is disposed in the imaging device such that the phase difference detection is accurately performed even when the exit pupil position is changed.

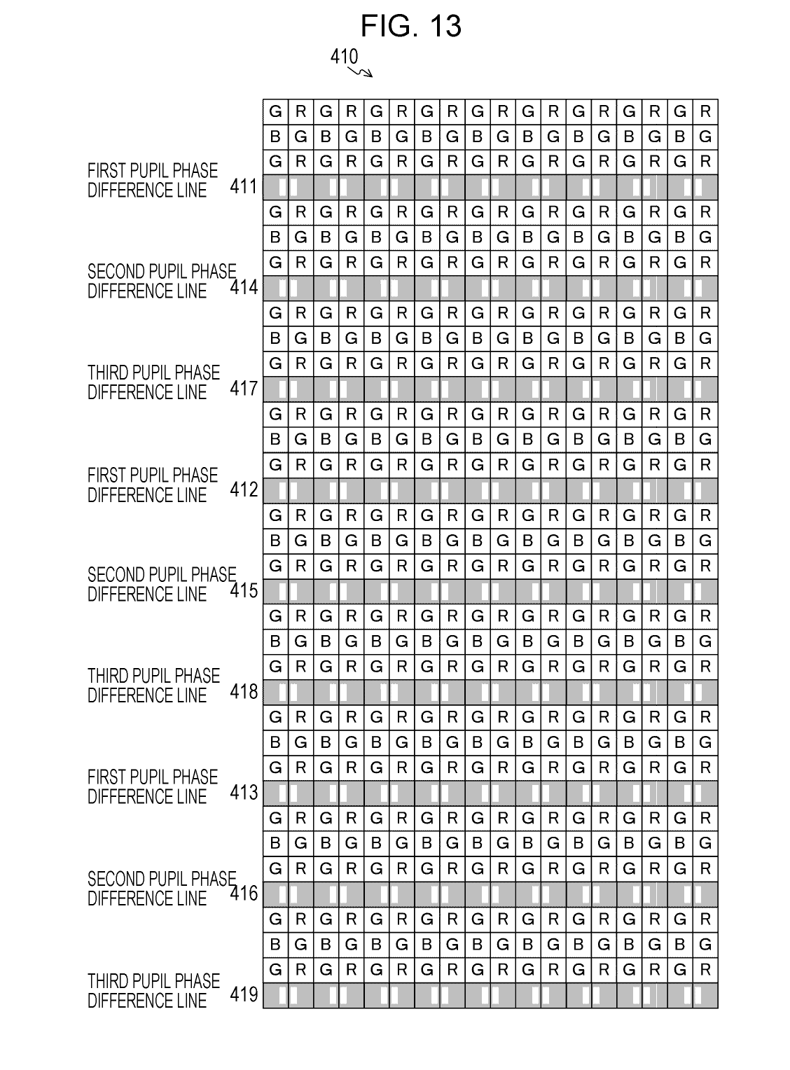

Accordingly, in the second embodiment of the present technology, referring to FIGS. 13 to 22, the description will be given of the abnormality detection and the correlation calculation of the imaging device in which the plurality of types of the phase difference detection pixels with appropriate different exit pupil positions is disposed.

It should be noted that, in the second embodiment of the present technology, the functional configuration of the imaging apparatus is the same as the functional configuration of the first embodiment of the present technology shown in FIG. 3, and thus the description thereof is omitted herein with reference to FIG. 3.

### Example of Arrangement of Pixels of Imaging Device

FIG. 13 is a schematic diagram illustrating an example of arrangement of pixels provided in the imaging device (imaging device 300) according to a second embodiment of the present technology.

In addition, the region (pixel region 410) of the pixels shown in FIG. 13, instead of the region (pixel region 310) of pixels shown in FIG. 4, is repeated in the X and Y axis directions in the imaging device 300. Here, a description will be given focusing on the difference with the pixel region 310 shown in FIG. 4.

As shown in FIG. 13, the pixel region 410 includes rows (lines), in which only the image generation pixels are disposed, and rows (lines), in which only the phase difference detection pixels are disposed, in a similar manner to the pixel region 310. The rows (the phase difference lines) of only the phase difference detection pixels are disposed with predetermined intervals in a direction (column direction) orthogonal to the reading direction (row direction) (at every fourth row in FIG. 13), and the rows of only the image generation pixels are disposed at the other rows.

Further, in the pixel region 410 of FIG. 13, the phase difference detection pixels are configured such that the pupil division is appropriately performed in any of three exit pupils (hereinafter referred to as a first pupil, a second pupil, and a third pupil) of which the positions from the imaging surface are different from one another. In the pixel region 410, the phase difference detection pixels corresponding to the exit pupils at the same position are disposed for each line. That is, the first pupil phase difference lines 411 to 413 shown in FIG. 13 are rows in which the phase difference detection pixels corresponding to the first pupil are disposed. In addition, the second pupil phase difference lines 414 to 416 are rows in which the phase difference detection pixels corresponding to the second pupil are disposed. Further, the third pupil phase difference lines 417 to 419 are rows in which the phase difference detection pixels corresponding to the third pupil are disposed.

Further, in the pixel region 410, in the phase difference lines at every fourth row, the lines, of which the corresponding exit pupils are different, are alternately disposed to be repeated. The different exit pupils correspond to the first pupil phase difference line, the second pupil phase difference line, the third pupil phase difference line, the first pupil phase difference line, the second pupil phase difference line, the third pupil phase difference line . . . .

As described above, the phase difference detection pixels, of which the corresponding exit pupils are different, are disposed on a line-by-line basis. Thereby, when reading the output signal, the lines, which do not correspond to the positions of the exit pupils of the interchangeable lens being mounted, are thinned out so as to be able to perform the reading.

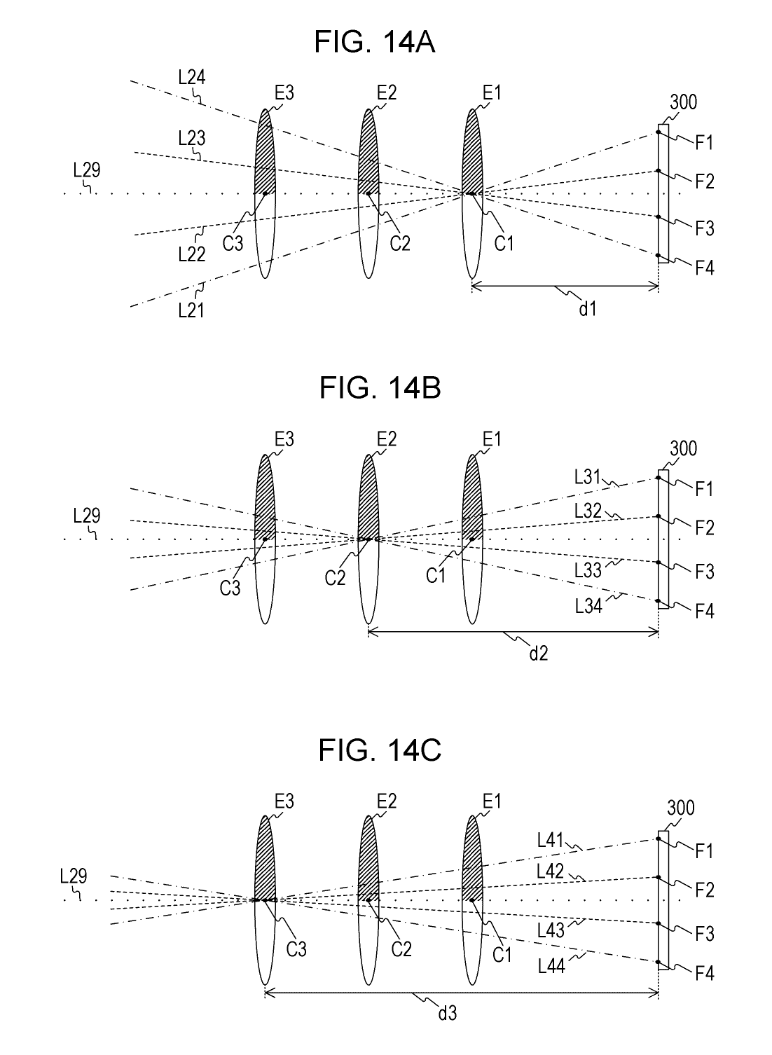

Next, the relationship between the exit pupil position and the pupil division will be described with reference to FIGS. 14A to 14C.

### Example of Relationship Between Pupil Division and Exit Pupils at Three Positions

FIGS. 14A to 14C are diagrams schematically illustrating the pupil division, which is performed by the phase difference detection pixels respectively corresponding to the exit pupils at three positions, in the second embodiment of the present technology.

FIG. 14A shows the pupil division which is performed by the phase difference detection pixels corresponding to the exit pupil (first pupil E1) at the position d1.

FIG. 14A shows the imaging device 300 and the three exit pupils (the first pupil E1, the second pupil E2, and the third pupil E3) at different distances from the imaging device 300. In addition, at the first pupil E1, the second pupil E2, and the third pupil E3, the center points (centers C1 to C4), which indicate the centers of the respective exit pupils, are shown.

In addition, the first pupil E1 corresponds to the first pupil shown in FIG. 13, and the phase difference detection pixels corresponding to the first pupil E1 correspond to the phase difference detection pixels disposed in the first pupil phase difference line. Accordingly, the phase difference detection pixels corresponding to the first pupil E1 are hereinafter referred to as first pupil phase difference detection pixels. Further, likewise, the phase difference detection pixels corresponding to the second pupil E2 and the third pupil E3 are referred to as second pupil phase difference detection pixels and third pupil phase difference detection pixels.

In the imaging device 300, four positions (positions F1 to F4) as positions of the phase difference detection pixels of the imaging device 300 are shown. The positions F1 and F4 indicate positions which are at the same distance (image height) from the center of the imaging device 300 and are opposite to each other from the center. Further, likewise, the positions F2 and F3 indicate positions which are at the same image height and are opposite to each other from the center. It should be noted that the vertical direction of the imaging device 300 shown in FIG. 14A is set as the horizontal direction (x axis direction) of the pixel region 410 shown in FIG. 13.

Further, FIG. 14A shows pupil division lines L21 to L24 as axes which indicate boundaries of the regions divided by the first pupil phase difference detection pixels among the phase difference detection pixels disposed at the positions F1 to F4.

Further, in the description of FIG. 14A, for convenience of description, it is assumed that the first pupil phase difference detection pixels at the positions F1 to F4 are phase difference detection pixels on the upper side of FIG. 14A which are covered with the light blocking section.

Here, the pupil division using the first pupil phase difference detection pixel at the position F1 will be described. The first pupil phase difference detection pixels are configured to perform the pupil division for dividing the first pupil E1 into two equal parts. Thereby, the first pupil phase difference detection pixel at the position F1 receives the subject light from the upper side of the pupil division line L21 relative to the pupil division line L21 which is set as the boundary. In addition, as a method of pupil division of the phase difference detection pixel corresponding to the position of the first pupil E1, for example, it may be possible to use a method (for example, refer to Japanese Unexamined Patent Application Publication No. 2009-204987) of making the position of the light-blocking layer different for each pixel for pupil division.

In the first pupil phase difference detection pixel at the position F1, a light-blocking layer is formed in accordance with a position of the first pupil E1. Thereby, the pupil division, which divides the first pupil E1 into two equal parts, can be performed. However, the pupil division line L21 is oblique to the optical axis (the dotted line L29 in the drawing). Hence, it is difficult to perform the pupil division so as to divide the exit pupil at another position into two equal parts. For example, the first pupil phase difference detection pixel at the position F1 receives the subject light which is transmitted through ¾ of the area of the second pupil E2 from the top of the second pupil E2. Further, the first pupil phase difference detection pixel receives the subject light which is transmitted through nine tenth of the area of the third pupil E3 from the top of the third pupil E3.

As described above, the first pupil phase difference detection pixel at the position F1 is able to accurately perform the phase difference detection on the first pupil E1 since the first pupil E1 at the position d1 can be pupil-divided into two equal parts. However, it is difficult to equally divide the subject light into two equal parts at the second pupil E2 and the third pupil E3, and thus it is difficult to accurately perform the phase difference detection.

In addition, similarly to the position F1, the first pupil phase difference detection pixels at the positions F2 to F4 are able to accurately perform the phase difference detection on the first pupil E1 by forming the light blocking section in accordance with the position of the first pupil E1. However, it is difficult to accurately perform the phase difference detection on the second pupil E2 and the third pupil E3.

As described above, the phase difference detection pixels (first pupil phase difference detection pixels) corresponding to the first pupil E1 are able to accurately perform the phase difference detection on the first pupil E1. However, it is difficult to accurately perform the phase difference detection on the second pupil E2 and the third pupil E3.

FIG. 14B shows the pupil division which is performed by the phase difference detection pixels (second pupil phase difference detection pixels) corresponding to the exit pupil (second pupil E2) at the position d2.

FIG. 14B shows, similarly to FIG. 14A, the imaging device 300 and the exit pupils (the first pupil E1, the second pupil E2, and the third pupil E3) at three positions. In addition, FIG. 14B shows, instead of the pupil division lines L21 to L24 shown in FIG. 14A, pupil division lines L31 to L34 as axes which indicate boundaries of the pupil division performed at the positions F1 to F4 by the second pupil phase difference detection pixels.

In the second pupil phase difference detection pixel, a light-blocking layer is formed to perform the pupil division which divides the second pupil E2 into two equal parts. That is, as shown in FIG. 14B, the second pupil phase difference detection pixel is able to accurately perform the phase difference detection on the second pupil E2. However, it is difficult to accurately perform the phase difference detection on the first pupil E1 and the third pupil E3.

FIG. 14C shows the pupil division which is performed by the phase difference detection pixels (third pupil phase difference detection pixels) corresponding to the exit pupil (third pupil E3) at the position d3.

FIG. 14C shows, similarly to FIGS. 14A and 14B, the imaging device 300 and the exit pupils (the first pupil E1, the second pupil E2, and the third pupil E3) at three positions. In addition, FIG. 14C shows, instead of the pupil division lines L21 to L24 shown in FIG. 14A, pupil division lines L41 to L44 as axes which indicate boundaries of the pupil division performed at the positions F1 to F4 by the third pupil phase difference detection pixels.

In the third pupil phase difference detection pixel, a light-blocking layer is formed to perform the pupil division which divides the third pupil E3 into two equal parts. That is, as shown in FIG. 14C, the third pupil phase difference detection pixel is able to accurately perform the phase difference detection on the third pupil E3. However, it is difficult to accurately perform the phase difference detection on the first pupil E1 and the second pupil E2.

As described above, the phase difference detection pixels corresponding to the exit pupils at different pupil positions are disposed in the imaging device 300. Thereby, when the imaging apparatus 100 is a single-lens reflex camera with an interchangeable lens unit, the imaging apparatus 100 is able to be compatible with interchangeable lenses of which the exit pupils are at different positions.

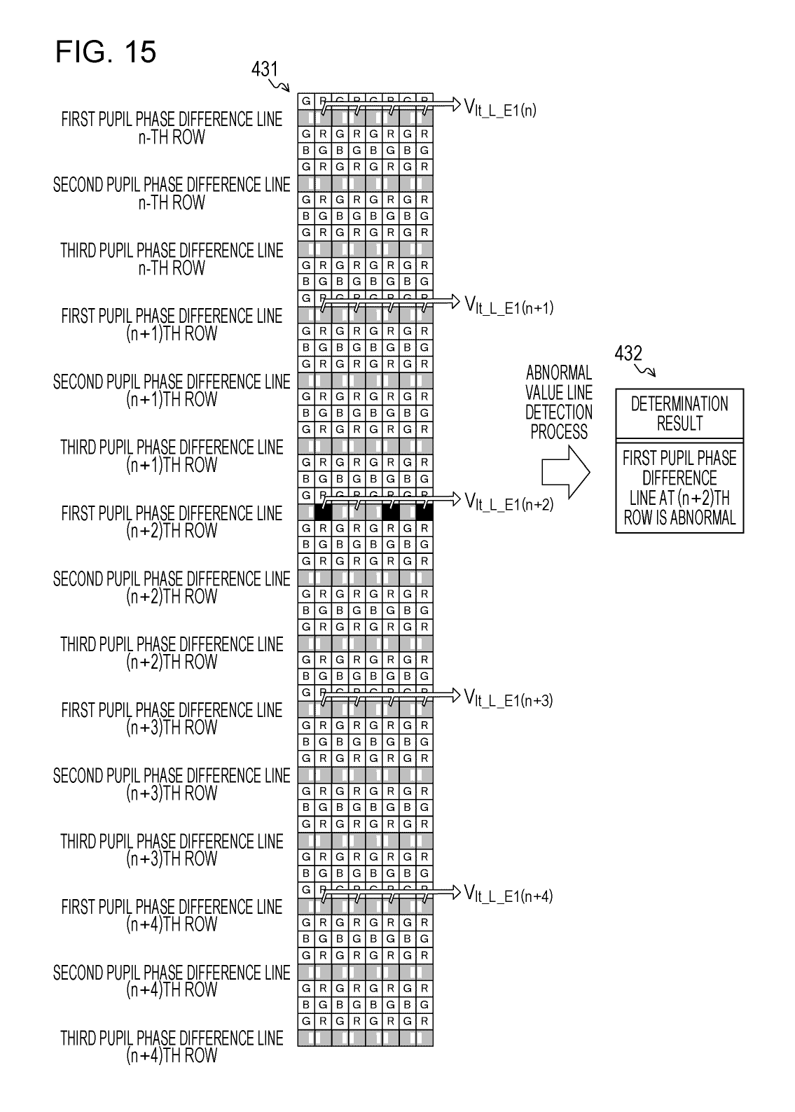

Next, referring to FIG. 15, a description will be given of abnormality detection which is performed on a row-by-row basis by the abnormal value line detection unit 262 in the imaging device (imaging device 300) where the phase difference detection pixels corresponding to the exit pupils at three positions are disposed.

### Example of Abnormality Detection on Row-By-Row Basis

FIG. 15 is a diagram schematically illustrating an example of the abnormality detection which is performed on a row-by-row basis by the abnormal value line detection unit 262 in the imaging device 300 according to the second embodiment of the present technology.

In the description of FIG. 15, it is assumed that a region (pixel region 431) of pixels arranged in 58 rows×8 columns is set as the base region, and the phase difference detection is performed using the first pupil phase difference line.

In the abnormality detection under the assumption, the line totals (Vₗₜ_{_{—}}_{L}_{_{—}}_{E1(n)} to Vₗₜ_{_{—}}_{L}_{_{—}}_{E1(n+4))} of the five first pupil phase difference lines (first pupil phase difference lines at n-th to (n+4)th rows) in the pixel region 431 are calculated, and the abnormality detection is performed using the calculated line total. That is, by using the line totals of the lines corresponding to the same exit pupil, it is determined whether or not there are line totals satisfying Expressions 1 and 2 shown in FIGS. 6A and 6B.

In addition, it is assumed that, in the pixel region 431, among the left opening phase difference detection pixels in the first pupil phase difference line at the (n+2)th row, there are defective (black defect) pixels with constantly low output values. Hence, it is determined that the line total (Vₗₜ_{_{—}}_{L}_{_{—}}_{E1(n+2)}) of the first pupil phase difference line at the (n+2)th row is an abnormal value, on the basis of Expression 1, and as shown in the table 432 of FIG. 15, it is determined that the first pupil phase difference line at the (n+2)th row is abnormal.

In addition, when there is an abnormal value line, in the first embodiment of the present technology, the abnormal value line is excluded, and the correlation is calculated. In the second embodiment of the present technology, in a similar manner to the first embodiment of the present technology, it is possible to calculate the correlation excluding the abnormal value line. However, in the second embodiment of the present technology, the phase difference line, which corresponds to the exit pupil at another position, is near the abnormal value line. Hence, in the second embodiment of the present technology, it is determined whether or not the output values of the abnormal value line can be substituted by the output values of the phase difference detection pixels of the near phase difference line. If it is possible to perform the substitution, the output values of the abnormal value line are substituted by the output values of the phase difference detection pixels of the near phase difference line, and then the correlation calculation is performed.

In addition, as methods of the substitution using the output values of the near phase difference line, various methods can be considered as follows: the output values of the phase difference line for a separate pupil position adjacent to the abnormal value line are directly used, or averages of the output values of the plurality of phase difference lines are used as the substitutes. In the second embodiment of the present technology, there are phase difference lines (in FIG. 15, the third pupil phase difference line at the (n+1)th row and the second pupil phase difference line at the (n+2)th row) which are adjacent to the abnormal value line. In this case, the output values of the phase difference line, of which the corresponding exit pupil is positioned to be close to the exit pupil of the abnormal value line, among the adjacent phase difference lines are used. An example of such a usage will be described.

Further, an example of the usage of the averages of the output values of the phase difference lines, which are adjacent to the abnormal value line, will be described later in a third embodiment.

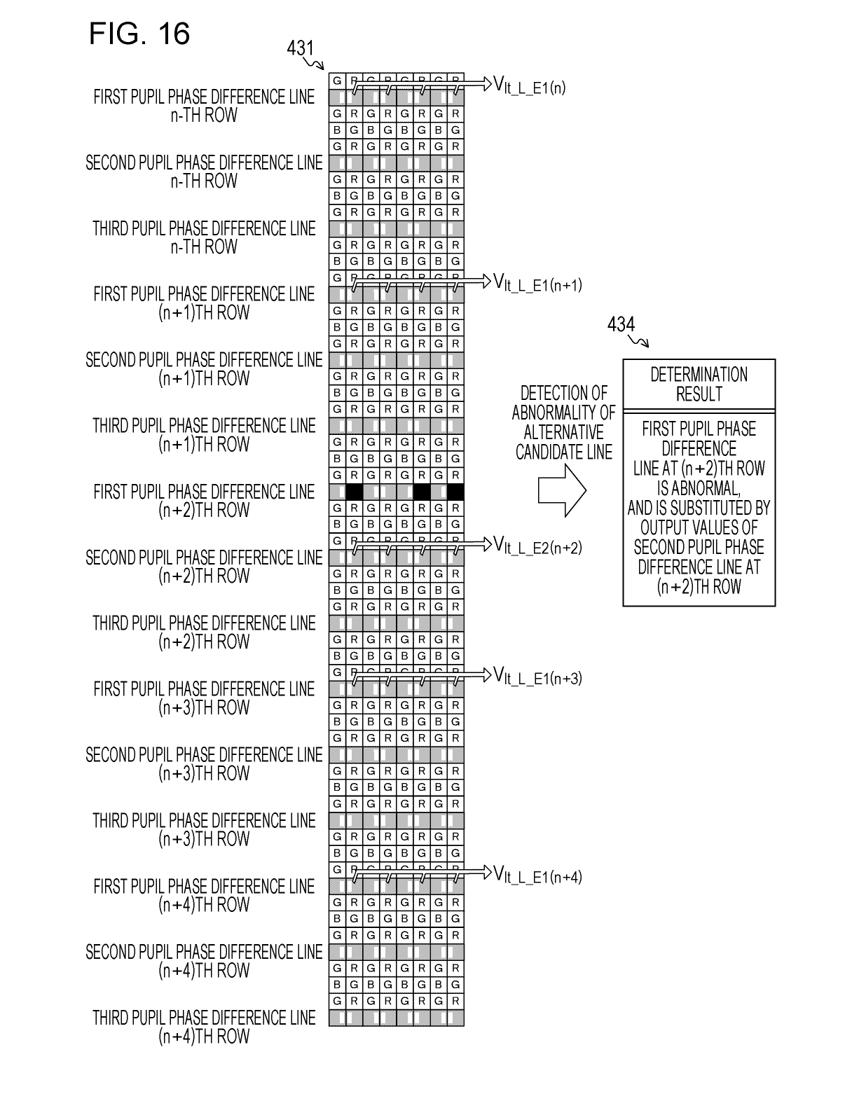

Next, the substitution of the phase difference line will be described with reference to FIG. 16.

### Example of Substitution of Phase Difference Line

FIG. 16 is a diagram schematically illustrating an example of determination that is made as to whether or not to use the phase difference line, which corresponds to the exit pupil at another position, as a substitute by the abnormal value line detection unit 262, in the second embodiment of the present technology.

If the abnormal value line detection unit 262 detects the abnormal value line, then, it is determined whether or not there is a phase difference line of which the output values can be used instead of that of the detected abnormal value line. In the second embodiment of the present technology, among the phase difference lines adjacent (closest) to the abnormal value line, the phase difference line, of which the corresponding exit pupil is positioned to be closer to that of the abnormal value line, is determined as a candidate for the alternative line. Then, it is determined that, when the line total of the line (candidate line) does not have an abnormal value, the line can be used as the substitute.

In addition, in the second embodiment of the present technology shown in FIG. 16, it is assumed that the second pupil is positioned to be closer to the first pupil than the third pupil (refer to FIGS. 14A to 14C). Hence, as shown in the pixel region 431 of FIG. 16, when the first pupil phase difference line at the (n+2)th row is an abnormal value line, the second pupil phase difference line at the (n+2)th row is determined as a candidate line, and it is determined whether or not the candidate line is abnormal.

The method of determining whether or not the candidate line is abnormal is the same as the method of abnormality determination on a line-by-line basis described hitherto. That is, by using the line total (Vₗₜ_{_{—}}_{L}_{_{—}}_{E2(n+2)}) of the second pupil phase difference line at the (n+2)th row as an alternative candidate and the line totals of the lines other than the abnormal value line of the first pupil phase difference line, Expressions 1 and 2 of FIGS. 6A and 6B are calculated. Then, when Expressions 1 and 2 are satisfied, it is determined that there is abnormality.

It should be noted that it is assumed that, in the pixel region 431, there is no defective pixel in the left opening phase difference detection pixels of the second pupil phase difference line at the (n+2)th row. Hence, it is determined that the line total of the second pupil phase difference line at the (n+2)th row does not have an abnormal value and can thus be used as a substitute. Then, as shown in the table 434 of FIG. 16, it is determined that the first pupil phase difference line at the (n+2)th row is an abnormal value line but can be substituted by the output values of the second pupil phase difference line at the (n+2)th row.

In addition, as shown in FIGS. 14A to 14C, at a position where the image height is high, when the output values of the phase difference detection pixels corresponding to the exit pupil at another position are used as substitutes, there is a possibility of using a value with a poor accuracy (equivalency between two divisions) in the pupil division. In this case, the output values of the line (alternative line), which is used as a substitute, are corrected, and then used in the correlation calculation.

### Operation Example of Imaging Apparatus

Next, an operation of the imaging apparatus according to the second embodiment of the present technology will be described with reference to the drawings.

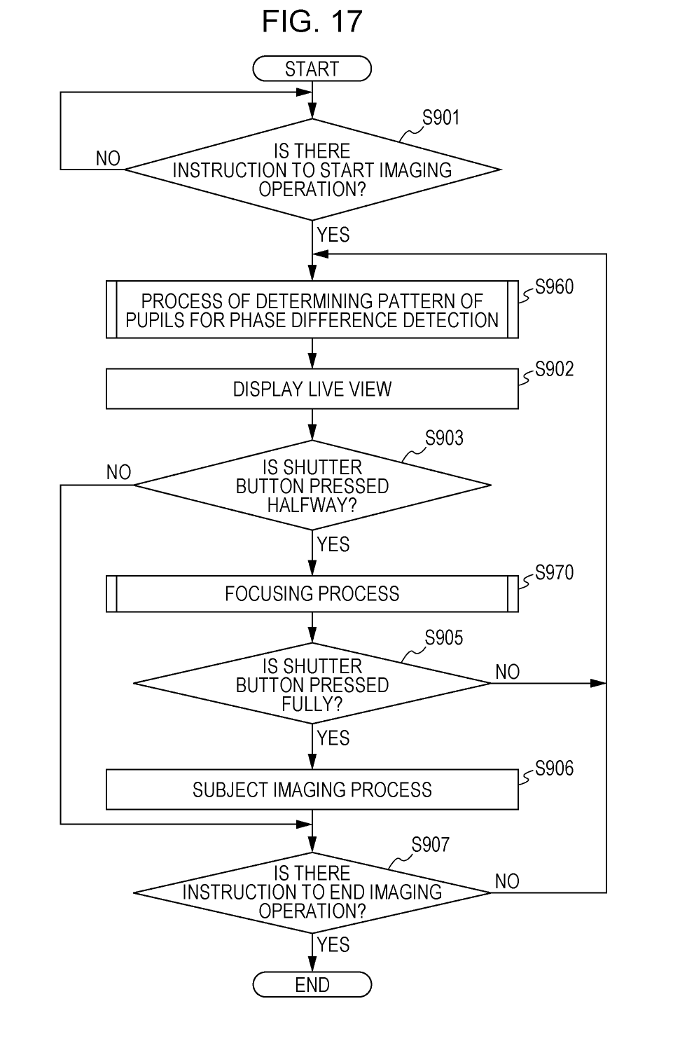

FIG. 17 is a flowchart illustrating an example of an imaging processing procedure of the imaging apparatus (imaging apparatus 100) according to the second embodiment of the present technology.

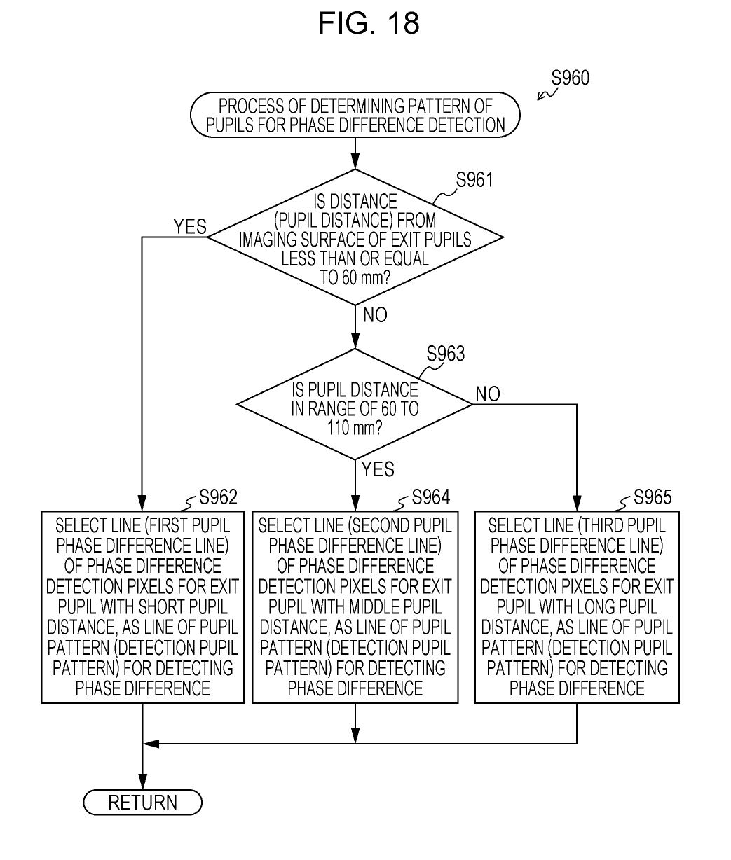

It should be noted that the imaging processing procedure shown in FIG. 17 is a modified example of the imaging processing procedure shown in FIG. 9, and a part of the procedure is different from the imaging processing procedure of FIG. 9. In the imaging processing procedure of FIG. 17, there is a process (process (step S960) of determining the pattern of the pupils for phase difference detection) of determining which phase difference line is used among the plurality of phase difference lines corresponding to different exit pupils. The process is applied before the step of displaying the live-view image (step S902). Further, if it is determined that there is no instruction to end the imaging operation in step S907, the procedure returns to step S960. It should be noted that the process (step S960) of determining the pattern of the pupils for phase difference detection will be described in FIG. 18, and thus the description thereof is omitted herein.

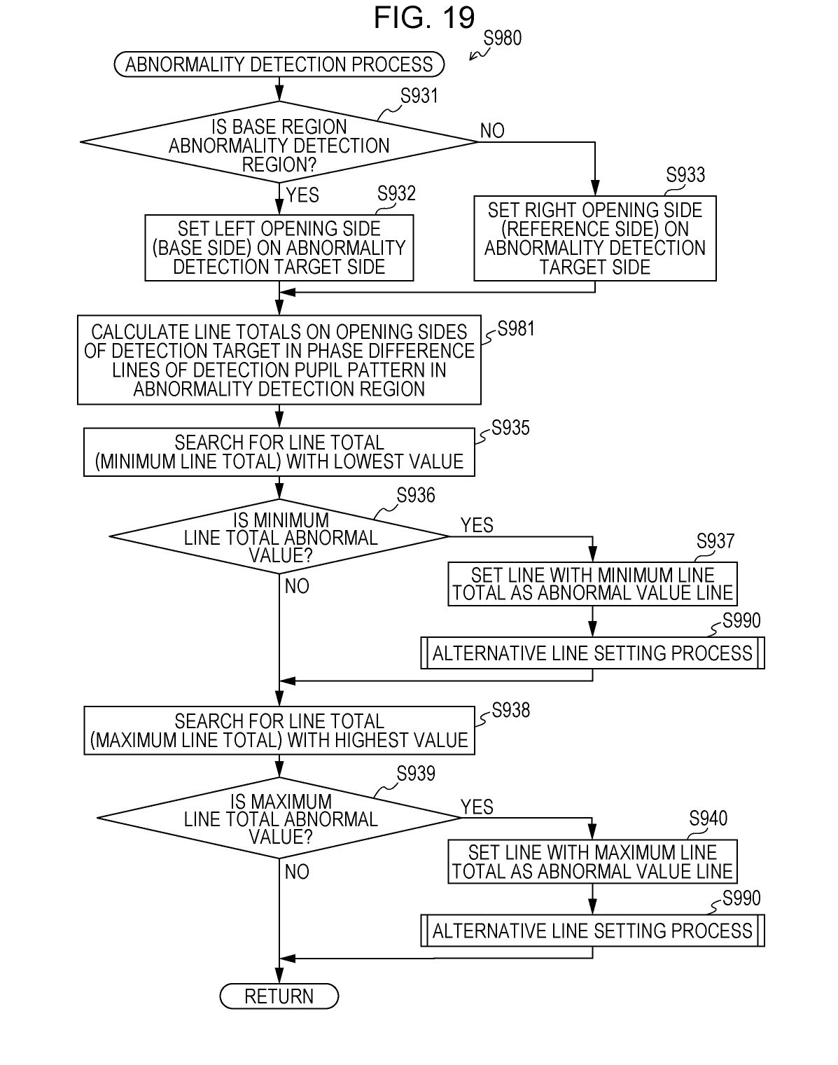

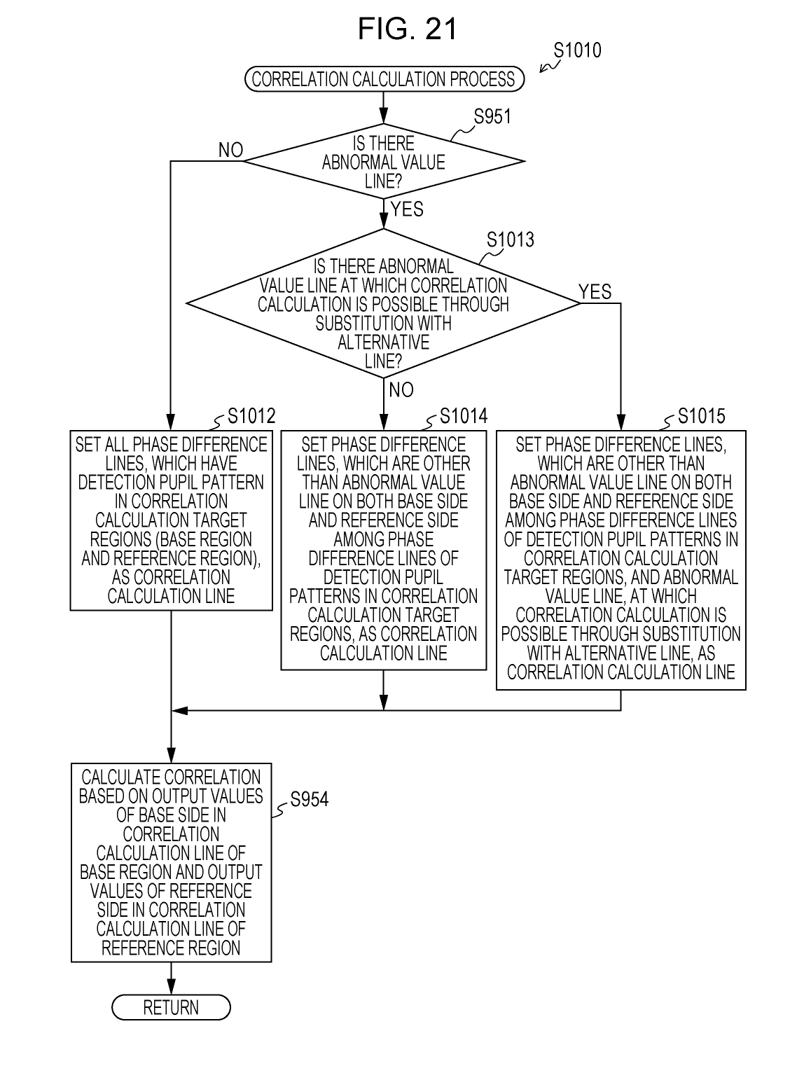

Further, in the imaging processing procedure of FIG. 17, the procedure of the focusing process is different from the procedure of the focusing process (step S910) of FIG. 9, and new reference numerals and signs are used in the focusing process (step S970). Furthermore, the focusing process (step S970) of FIG. 17 is a modified example of the focusing process (step S910) of FIG. 9, and the procedure thereof is different in the abnormality detection process (step S930) and the correlation calculation process (step S950). In addition, the abnormality detection process in the second embodiment of the present technology will be described in step S980 with reference to FIG. 19. Moreover, the correlation calculation process in the second embodiment of the present technology will be described in step S1010 with reference to FIG. 21. In addition, the other procedure is the same as the procedure in the first embodiment of the present technology, and thus the description thereof is omitted herein.

FIG. 18 is a flowchart illustrating an example of a procedure of a process of determining the pattern of the pupils for phase difference detection (step S960) in the imaging processing procedure according to the second embodiment of the present technology.

First, it is determined whether or not the distance (pupil distance) from the imaging surface of the exit pupil is less than or equal to 60 mm (step S961). Then, if it is determined that the pupil distance is less than or equal to 60 mm (step S961), the lines (first pupil phase difference lines) of the phase difference detection pixels for the exit pupil, of which the pupil distance is short, are selected as lines of the pupil pattern (detection pupil pattern) for detecting the phase difference (step S962). Subsequently, after step S962, the procedure of the process of determining the pattern of the pupils for phase difference detection ends.

In contrast, if it is determined that the pupil distance is more than 60 mm (step S961), it is determined whether or not the pupil distance is in the range of 60 mm to 110 mm (step S963). Then, if it is determined that pupil distance is in the range of 60 mm to 110 mm (step S963), the lines (second pupil phase difference lines) of the phase difference detection pixels for the exit pupil, of which the pupil distance is middle, are selected as lines of the pupil pattern (detection pupil pattern) for detecting the phase difference (step S964). Subsequently, after step S964, the procedure of the process of determining the pattern of the pupils for phase difference detection ends.

Further, if it is determined that pupil distance is not in the range of 60 mm to 110 mm (step S963), the lines (third pupil phase difference lines) of the phase difference detection pixels for the exit pupil, of which the pupil distance is long, are selected as lines of the pupil pattern (detection pupil pattern) for detecting the phase difference (step S965). Subsequently, after step S965, the procedure of the process of determining the pattern of the pupils for phase difference detection ends.

FIG. 19 is a flowchart illustrating an example of a procedure of an abnormality detection process (step S980) in the imaging processing procedure according to the second embodiment of the present technology.

In addition, the abnormality detection process (step S980) is a modified example of the abnormality detection process (step S930) shown in FIG. 11. Hence, only the different part of the procedure is described herein, and in the same part of the procedure, the same reference numerals and signs are used, and the description thereof is omitted herein.

When the abnormality detection target side is set in step S932 or S933, the line totals of the opening side of the detection targets of the phase difference lines of the detection pupil pattern in the abnormality detection region are calculated (step S981), and the procedure advances to step S935.

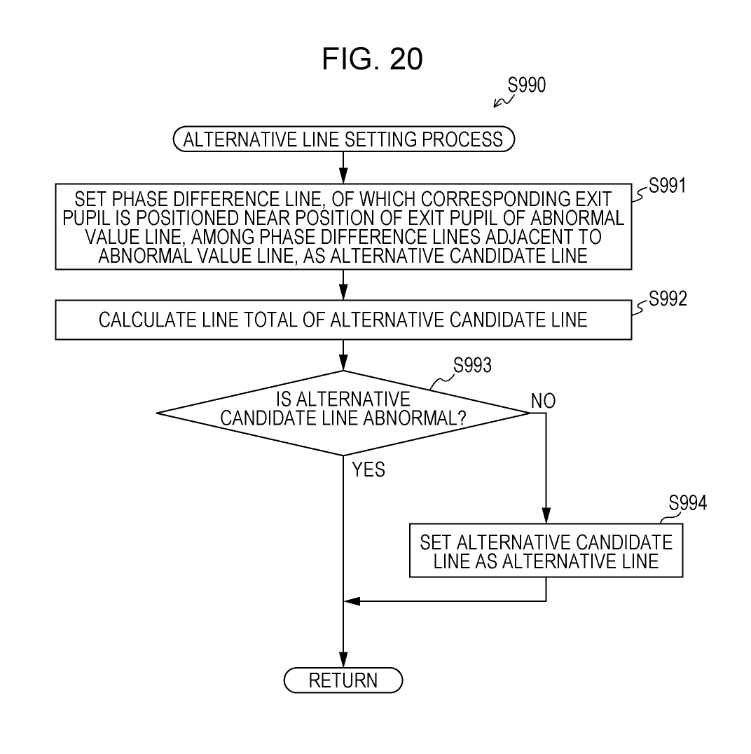

When the line with the maximum line total is set as an abnormal value line in step S937, the process (alternative line setting process) of setting the alternative line is performed (step S990), and the procedure advances to step S938. It should be noted that the alternative line setting process (step S990) will be described in FIG. 20, and thus the description thereof is omitted herein.

When the line with the minimum line total is set as an abnormal value line in step S940, the alternative line setting process is performed (step S990), and the procedure of the abnormality detection process ends.

FIG. 20 is a flowchart illustrating an example of the procedure of the alternative line setting process (step S990) in the imaging processing procedure according to the second embodiment of the present technology.

First, among the phase difference lines which are adjacent to the abnormal value line, the phase difference line, of which the corresponding exit pupil is positioned to be close to the exit pupil of the abnormal value line, is set as an alternative candidate line (step S991).

Thereafter, the line total of the alternative candidate line is calculated (step S992), and it is determined whether or not the line total of the alternative candidate line is abnormal (step S993). Then, if it is determined that the line total of the alternative candidate line is abnormal (step S993), the procedure of the alternative line setting process ends.

In contrast, if it is determined that the line total of the alternative candidate line is not abnormal (step S993), the alternative candidate line is set as an alternative line (step S994), and the procedure of the alternative line setting process ends.

FIG. 21 is a flowchart illustrating an example of a procedure of a correlation calculation process (step S1010) in the imaging processing procedure according to the second embodiment of the present technology.

It should be noted that the correlation calculation process (step S1010) shown in FIG. 21 is a modified example of the correlation calculation process (step S950) shown in FIG. 12, and is different in that the processes relating to the alternative line and the pupil pattern are added thereto. Accordingly, in the same part of the procedure, the same reference numerals and signs are used, and the description thereof is omitted herein.

If it is determined that the abnormal value line is not included in step S951, all the phase difference lines of the detection pupil pattern in the determination area are set as the correlation calculation lines (step S1012), and the procedure advances to step S954.

In contrast, if it is determined that the abnormal value line is included in step S951, it is determined whether or not there is an abnormal value line which can be subjected to the correlation calculation by using the alternative line as a substitute (step S1013). Then, if it is determined that there is no abnormal value line which can be subjected to the correlation calculation by using the alternative line as a substitute (step S1013), among the phase difference lines of the detection pupil pattern in the correlation calculation target region, the phase difference lines other than the abnormal value line on both the base side and the reference side are set as the correlation calculation lines (step S1014), and the procedure advances to step S954.

Further, if it is determined that there is an abnormal value line which can be subjected to the correlation calculation by using the alternative line as a substitute (step S1013), among the phase difference lines of the detection pupil pattern in the correlation calculation target region, the phase difference lines other than the abnormal value line on both the base side and the reference side and the abnormal value line, which can be subjected to the correlation calculation by using the alternative line as a substitute, are set as the correlation calculation lines (step S1015), and the procedure advances to step S954.

As described above, according to the second embodiment of the present technology, by substituting the output values of the abnormal value line by the output values of the phase difference line near the abnormal value line, it is possible to perform the phase difference detection.

In addition, the second embodiment of the present technology has described the example of the phase difference detection pixels of the three patterns which respectively correspond to the three pupil positions (first pupil, second pupil, third pupil). However, the present technology is not limited to the three positions, and the patterns may correspond to the pupil positions of which the number is greater than that. In this case, it is conceivable that not only the phase difference lines which are adjacent to the abnormal value line but also the phase difference line slightly farther from the abnormal value line may be set as an alternative line.

Next, in a third embodiment, a description will be given of an example in which the averages of the output values of the phase difference lines adjacent to the abnormal value line are used.

### 3. Third Embodiment

### Operation Example of Imaging Apparatus

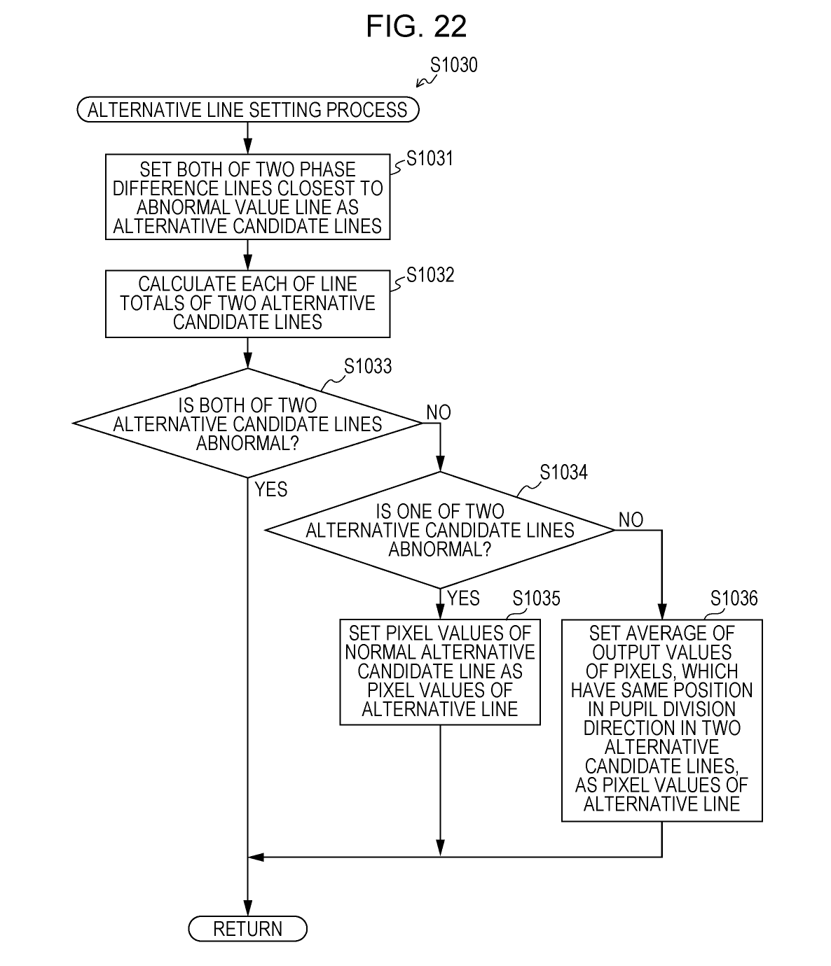

FIG. 22 is a flowchart illustrating an example of a procedure of an alternative line setting process (step S1030) in the imaging processing procedure according to the third embodiment of the present technology.

In addition, the alternative line setting process (step S1030) of FIG. 22 is a modified example of the alternative line setting process (step S990) shown in FIG. 20.

First, both of the two phase difference lines adjacent to the abnormal value line are set as alternative candidate lines (step S1031), and the line totals of the two alternative candidate lines are respectively calculated (step S1032). Thereafter, it is determined whether or not both of the two alternative candidate lines are abnormal (step S1033). The determination is made using the line totals of the respective alternative candidate lines and using Expressions 1 and 2 of FIGS. 6A and 6B as shown in FIG. 16.

Then, if it is determined that both of the two alternative candidate lines are abnormal (step S1033), the procedure of the alternative line setting process ends. That is, if it is determined that both are abnormal, there is no alternative line.

In contrast, if it is not determined that both of the two alternative candidate lines are abnormal (step S1033), it is determined whether or not one of the two alternative candidate lines is abnormal (step S1034). Then, if it is determined that one of the two alternative candidate lines is abnormal (step S1034), the output values of the alternative candidate line, which is not abnormal (normal), are set as output values of the alternative line (step S1035), and the procedure of the alternative line setting process ends.

In addition, if it is not determined that one of the two alternative candidate lines is abnormal (both of the two alternative candidate lines are normal) (step S1034), the averages of the output values of the pixels at the same positions in the pupil division direction in the two alternative candidate lines are set as the output values of the alternative line (step S1036). Then, after step S1036, the procedure of the alternative line setting process ends. That is, the averages of the output values between the phase difference detection pixels of the two alternative candidate lines at the same positions in the pupil division direction are set as the output values of the alternative line.

FIG. 22 shows an example in which the output values of the alternative line are set by simply averaging the output values of the two alternative candidate lines in step S1036. However, the present technology is not limited to this. For example, it is conceivable to set values which are weighted in accordance with the pupil positions and are then averaged.

As described above, according to the third embodiment of the present technology, the output values of the abnormal value line can be substituted by the averages of the output values of the phase difference lines which are adjacent to the abnormal value line.

### 4. Fourth Embodiment

In the description of the first to third embodiments of the present technology, it is the premise that there is only one line which includes an abnormal pixel in the base region or the reference region. However, when a large foreign particle is attached to the imaging device, it is conceivable that a plurality of lines may entirely become abnormal. In this case, in the abnormality detection method of the first to third embodiments on the premise that here is only one abnormal value line, there is a concern that the abnormal phase difference line may be erroneously detected as a normal phase difference line.

Accordingly, in the fourth embodiment of the present technology, it is assumed that the plurality of lines entirely becomes abnormal, and the abnormal value line is detected. Specifically, the abnormal value line detection unit 262 of the fourth embodiment detects the abnormal value line on the basis of the results of comparison between the line totals and the threshold value of a predetermined value in the abnormality detection region. For example, by setting at least one of a lower limit threshold value and an upper limit threshold value, the line of the line total, which is lower than the lower limit threshold value, or the line total, which is higher than the upper limit threshold value, is detected as the abnormal value line. When a plurality of abnormal value lines is detected by the detection method, the abnormal value line detection unit 262 changes the abnormality detection region. For example, the abnormality detection region is scaled down at a certain reduction ratio. Alternatively, the abnormal value line detection unit 262 changes the abnormality detection region such that the number of abnormal value lines becomes one. Here, the upper limit threshold value, the lower limit threshold value, and the reduction ratio are set in a register and the like in the main control unit 136, and can thereby be changed to be programmable. Then, the abnormal value line detection unit 262 detects the abnormal value line in the same method of the first to third embodiments in the changed abnormality detection region.

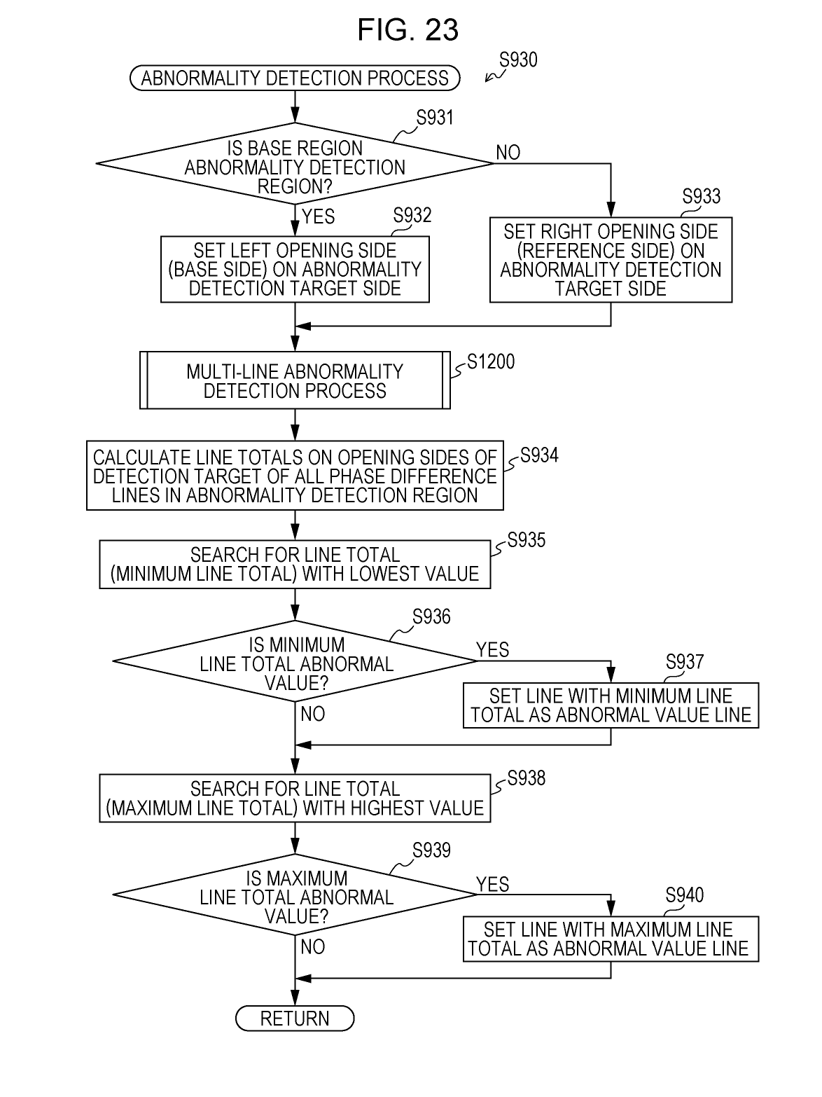

FIG. 23 is a flowchart illustrating an example of a procedure of an abnormality detection process (step S930) in the imaging processing procedure according to a fourth embodiment of the present technology. The abnormality detection process (step S930) shown in FIG. 23 is a modified example of the abnormality detection process (step S930) shown in FIG. 11, and is different in that a process of detecting whether or not there is the plurality of abnormal value detection lines is added. Accordingly, in the same part of the procedure, the same reference numerals and signs are used, and the description thereof is omitted herein.

In the abnormality detection process, after step S932 or S933, a multi-line abnormality detection process for detecting a plurality of abnormal value lines is additionally executed (step S1200). After step S1200, the processes in and after step S934 are executed.

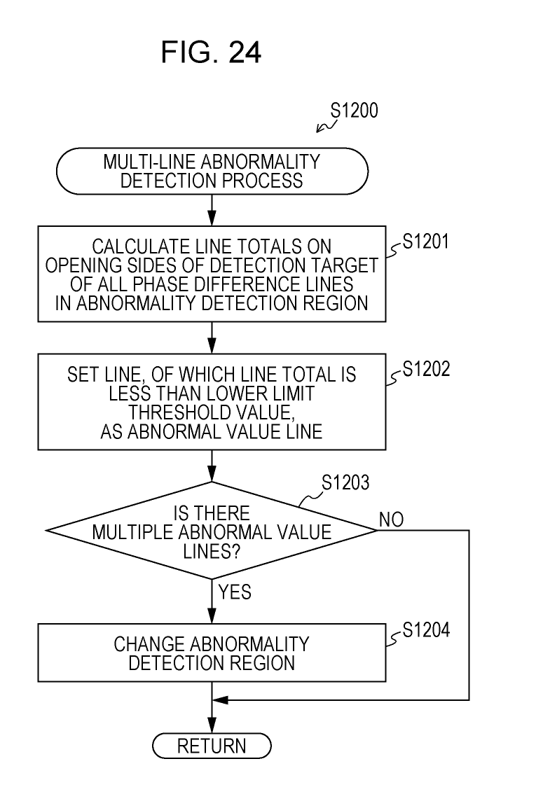

FIG. 24 is a flowchart illustrating an example of the procedure of the multi-line abnormality detection process (step S1200) in the imaging processing procedure according to the fourth embodiment of the present technology. First, the line totals of the respective phase difference lines are calculated on the basis of the output values of the phase difference detection pixels, of which the opening side is the detection target side, in all the phase difference lines in the abnormality detection region (step S1201).

Then, on the basis of the calculated phase difference lines, the phase difference line, of which the line total is less than the lower limit threshold value, is set as an abnormal value line (step S1202). Next, it is determined whether or not there is a plurality of abnormal value lines (step S1203). If there is a plurality of abnormal value lines (step S1203), the abnormality detection region is changed to include a single abnormal value line (step S1204). If there is a single abnormal value line (step S1203), or, after step S1204, the multi-line abnormality detection process ends.

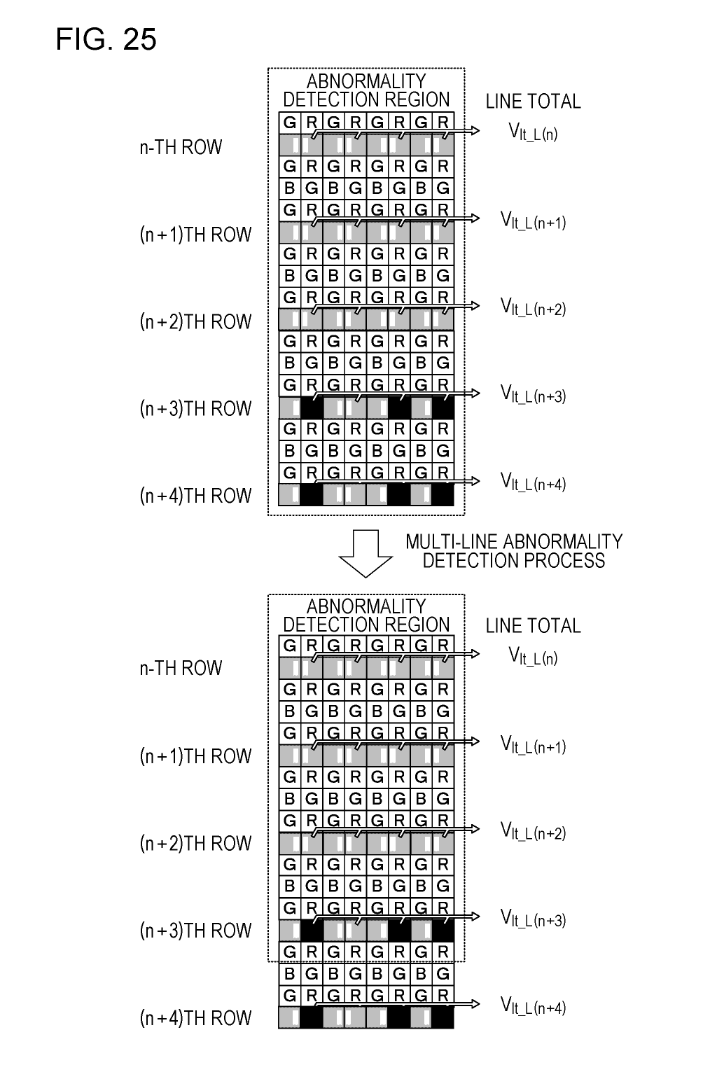

FIG. 25 is a diagram illustrating an example of an abnormality detection region in the fourth embodiment of the present technology. In FIG. 25, the region surrounded by the dotted line corresponds to the abnormality detection region. For example, the region, which includes the phase difference lines at n-th to (n+4)th rows, is set as the abnormality detection region. In the abnormality detection region, on the basis of all the output values of the phase difference detection pixels on the left opening side (L), the line totals of the respective phase difference lines are calculated. Here, it is assumed that the line totals of the phase difference lines at the (n+3)th and (n+4)th rows are less than the lower limit threshold value (for example, 20). In this case, the abnormality detection region is changed to include a single abnormal value line. For example, the line at the (n+4)th row closer to the outside is excluded, and a region, which includes the phase difference lines at the n-th to (n+3)th rows, is set as a new abnormality detection region. When there are three abnormal value lines, it is preferable that, among those, the innermost abnormal value line may be left, and the other abnormal value lines may be excluded. By using Expressions 1 and 2 in the new abnormality detection region, the abnormal value line is detected.

As described above, according to the embodiments of the present technology, if a plurality of abnormal value lines is detected, a new abnormality detection region is set. As a result, even when there is a plurality of abnormal value lines, it is possible to improve the accuracy of the phase difference detection.

### 5. Modified Example

The first to fourth embodiments of the present technology have described examples of the imaging device in which the pairs of phase difference detection pixels (left opening phase difference detection pixel and right opening phase difference detection pixel) are alternately disposed in the phase difference lines (rows). It should be noted that it is conceivable that there are other various examples of the arrangement of the phase difference detection pixels in the imaging device. Even in examples other than the arrangement of the phase difference detection pixels shown in the first to fourth embodiments of the present technology, by detecting abnormality of the phase difference detection pixels for each line so as not to use the line including the abnormal pixel in the correlation calculation, it is possible to improve the accuracy of the phase difference detection.

Next, the examples other than the arrangement of the phase difference detection pixels shown in the first to fourth embodiments of the present technology will be described with reference to FIGS. 26 to 28.

FIG. 26 is a diagram illustrating an example of a pixel arrangement in the imaging device, which is able to perform reading on the row-by-row basis and in which phase difference detection pixels performing pupil division in the column direction (vertical direction) are disposed on a column-by-column basis, as a modified example of the embodiment of the present technology.

In a case of the pixel arrangement shown in FIG. 26, phase difference detection is performed by setting columns in which pairs of phase difference detection pixels (lower opening phase difference detection pixels 811 and upper opening phase difference detection pixels 812) subjected to the pupil division in the vertical direction are disposed, as the phase difference lines shown in the first to fourth embodiments of the present technology. Thereby, in a similar manner to the first to fourth embodiments of the present technology, the present technology can be applied.

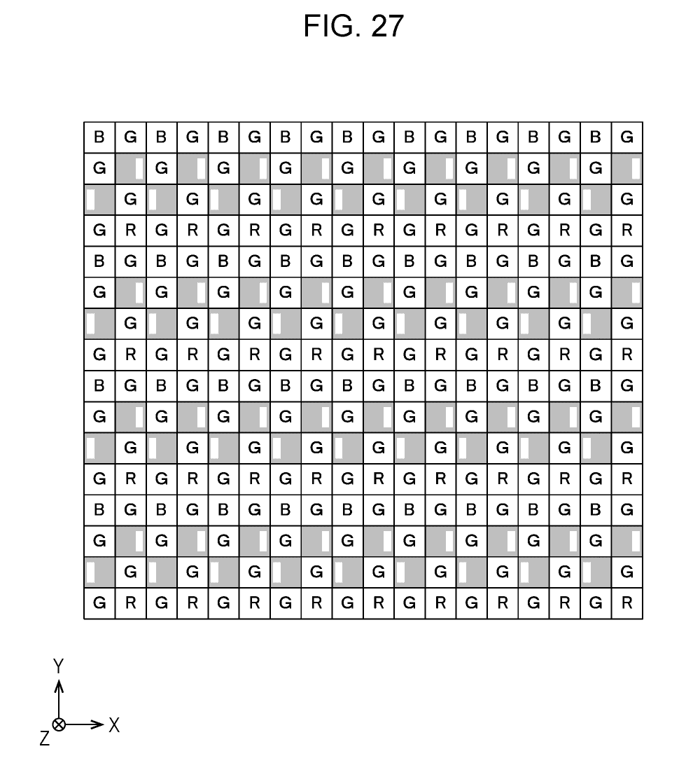

FIG. 27 is a diagram illustrating an example in which the phase difference detection pixels performing the pupil division in the row direction (horizontal direction) are respectively disposed at separate rows in the imaging device, which is able to perform reading on the row-by-row basis, as a modified example of the embodiment of the present technology. In FIG. 27, pairs of rows, at which only the image generation pixels are disposed, and pairs of rows (referred to as the phase difference line in a similar manner to the first embodiment), at which the phase difference detection pixels and image generation pixels are disposed, are alternately disposed. In one of the adjacent phase difference lines of two rows, the right opening phase difference detection pixels and G pixels are alternately disposed. In the other one of the adjacent phase difference lines, the left opening phase difference detection pixels and the G pixels are alternately disposed.

In a case of arrangement shown in FIG. 27, one of the adjacent phase difference lines of two rows is used as a line on the base side, and the other one is used as a line on the reference side, thereby performing the phase difference detection. As described above, even in the case of such pixel arrangement as only one of each pair of phase difference detection pixels being disposed in each phase difference line, the present technology can be applied in a similar manner to the first to fourth embodiments of the present technology.

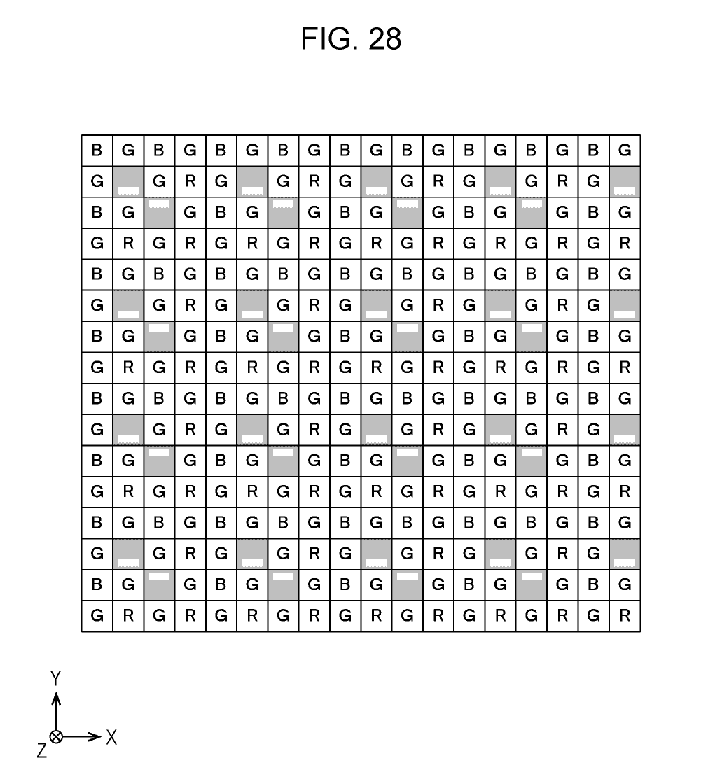

FIG. 28 is a diagram illustrating an example in which the phase difference detection pixels performing the pupil division in the column direction (vertical direction) are respectively disposed at separate rows in the imaging device, which is able to perform reading on the row-by-row basis, as a modified example of the embodiment of the present technology. In FIG. 28, pairs of columns, at which only the image generation pixels are disposed, and pairs of columns (referred to as the phase difference line in a similar manner to the first embodiment), at which the phase difference detection pixels and image generation pixels are disposed, are alternately disposed. In one of the adjacent phase difference lines of two columns, the lower opening phase difference detection pixel and three image generation pixels are alternately disposed. In the other one of the adjacent phase difference lines, the upper opening phase difference detection pixel and three image generation pixels are alternately disposed.

In a case of arrangement shown in FIG. 28, one of the adjacent phase difference lines of two columns is used as a line on the base side, and the other one is used as a line on the reference side. Thereby, the present technology can be applied in a similar manner to the first to fourth embodiments of the present technology.

As described above, according to the embodiments of the present technology, it is possible to improve the accuracy in the phase difference detection in the region where the phase difference detection pixel generating an abnormal value is present. In addition, in the method of detecting the abnormal value shown in the embodiments of the present technology, it is possible to check the abnormal phase difference detection pixel immediately before performing the phase difference detection. Hence, for example, it is possible to detect an abnormality appropriately even when the output of the phase difference detection pixel becomes abnormal due to adhesion of dirt in use such as adhesion of dust to the imaging surface at the time of replacing the lens. That is to say, it is possible to appropriately detect the phase difference detection pixel which becomes abnormal after manufacture.

Further, in the correlation calculation method shown in the embodiments of the present technology, the phase difference detection pixel, which generates an abnormal value due to a defect or adhesion of a foreign particle, is not used in the correlation calculation. Hence, it is possible to prevent deterioration of the detection performance overall, and it is possible to improve the accuracy in the phase difference detection. In particular, abnormality is detected in units of lines of the region (base region or reference region) used in phase difference detection, and thus it is possible to detect the abnormality quickly.

In addition, in the embodiments of the present technology, the description has been made assuming that a color filter to be provided for the image generation pixels is a three-primary-color (RGB) filter, but the color filter is not limited to this. For example, even in a case where a complementary-color filter is provided for the image generation pixels, the embodiments of the present technology can be applied in a similar way. Further, even in a case where a pixel for detecting rays of all wavelengths of a visible light region using one pixel region (for example, imaging device in which a pixel for blue color, a pixel for green color, and a pixel for red color are disposed in the optical axis direction in an overlapped manner) is an image generation pixel, the embodiments of the present technology can be applied in a similar way.

Further, in the embodiments of the present technology, the description has been made assuming that the phase difference detection pixels receive one of two pupil-divided rays, but the light receiving method is not limited to this. For example, even in a case of a phase difference detection pixel which includes two light-receiving elements instead of a light-blocking layer for pupil division and is able to receive pupil-divided rays by the light-receiving elements respectively, the embodiments of the present technology can be applied. Further, even in a case of a phase difference detection pixel which has a half-sized light-receiving element instead of a light-blocking layer for pupil division and is able to receive one of pupil-divided rays by the half-sized light-receiving element, the embodiments of the present technology can be applied in a similar way.

It should be noted that the above-mentioned embodiments are an example for realizing the present technology, and features in the embodiments have correspondence relations with features in the claims, respectively. Likewise, features in the claims and features in the embodiments of the present technology represented by the same names as these have correspondence relations, respectively. However, the present technology is not limited to the embodiments, and may be realized through various modifications of the embodiments without departing from the scope thereof.

Further, the procedures described in the above-mentioned embodiment may be regarded as a method including the series of steps, or may be regarded as a program, which causes a computer to execute the series of steps, or a recording medium which stores the program thereof. Examples of the recording medium include a hard disk, a compact disc (CD), a mini disc (MD), a digital versatile disc (DVD), a memory card, and a Blu-ray disc (registered trademark).

It should be noted that the present technology may have the following configurations.

(1) An imaging apparatus including: an imaging device that includes a plurality of pairs of phase difference detection pixels, where a plurality of phase difference lines along pupil division directions is disposed in an orthogonal direction which is orthogonal to the pupil division direction; a detection unit that detects an abnormal value among output values, which are output by the phase difference detection pixels, on the basis of a result of comparison of the output values between the plurality of phase difference lines; and a phase difference line determination unit that determines, as used lines, a plurality of phase difference lines, which are used in phase difference detection, among the plurality of phase difference lines in a phase difference detection region, on the basis of a detection result which is obtained by the detection unit.

(2) The imaging apparatus according to (1), in which the phase difference line determination unit determines the used lines by excluding an abnormal value line, which is a phase difference line including the phase difference detection pixel that outputs the abnormal value, from the plurality of phase difference lines.

(3) The imaging apparatus according to (1) or (2), in which the detection unit calculates a line total for each of the phase difference lines by performing computation using the output values of the phase difference detection pixels included in the phase difference line, and detects the abnormal value line on the basis of a result of comparison between the line totals.

(4) The imaging apparatus according to (3), in which the detection unit detects the abnormal value line on the basis of a result of comparison between a predetermined threshold value and the line totals, sets a new region when detecting a plurality of the abnormal value lines, and detects the abnormal value line on the basis of a result of comparison between the line totals in the new region.

(5) The imaging apparatus according to (3), in which the detection unit calculates the line total for each of a base region and a reference region which are set to perform correlation calculation in a phase difference detection target region including the plurality of phase difference lines, and detects the abnormal value line for each of the base region and the reference region.

(6) The imaging apparatus according to (5), in which the detection unit detects the abnormal value line in the base region on the basis of the line total which is obtained by adding the output values of one of the pair of phase difference detection pixels, and detects the abnormal value line in the reference region on the basis of the line total which is obtained by adding the output values of the other of the pair of phase difference detection pixels.

(7) The imaging apparatus according to (1), in which the phase difference line determination unit determines whether or not it is possible to perform the phase difference detection using alternative candidates as the output values of the phase difference lines, which are disposed near the abnormal value line as the phase difference line including the phase difference detection pixel that outputs the abnormal value, instead of the output values of the abnormal value line, and determines the plurality of phase difference lines, which include the abnormal value line, as the used lines on the basis of the detection result which is obtained by the detection unit when determining that it is possible to perform the phase difference detection.

(8) The imaging apparatus according to (7), in which in the imaging device, a plurality of phase difference detection pixels corresponding to any of a plurality of exit pupils, of which positions are different in an optical axis direction, is disposed, in which in the phase difference lines, the phase difference detection pixels are arranged such that one phase difference line corresponds to the exit pupil at one position, and the phase difference lines are arranged to respectively correspond to the exit pupils different from the exit pupils corresponding to the phase difference lines adjacent in the orthogonal direction, and in which a focusing determination unit sets the output values of the phase difference line, of which the corresponding exit pupil is closer to the exit pupil corresponding to the abnormal value line, between the two phase difference lines, which are adjacent to the abnormal value line in the orthogonal direction, as the alternative candidates.

(9) The imaging apparatus according to (7), in which in the imaging device, a plurality of phase difference detection pixels corresponding to any of a plurality of exit pupils, of which positions are different in an optical axis direction, is disposed, in which in the phase difference lines, the phase difference detection pixels are arranged such that one phase difference line corresponds to the exit pupil at one position, and the phase difference lines are arranged to respectively correspond to the exit pupils different from the exit pupils corresponding to the phase difference lines adjacent in the orthogonal direction, and in which the phase difference line determination unit calculates the alternative candidates by computing the output values of the two phase difference lines which are adjacent to the abnormal value line in the orthogonal direction.

(10) An imaging method including: acquiring output values which are output by phase difference detection pixels of an imaging device that includes a plurality of pairs of phase difference detection pixels, where a plurality of phase difference lines along pupil division directions is disposed in an orthogonal direction which is orthogonal to the pupil division direction; detecting an abnormal value among output values, which are output by the phase difference detection pixels, on the basis of a result of comparison of the output values between the plurality of phase difference lines; and determining, as used lines, a plurality of phase difference lines, which are used in phase difference detection, among the plurality of phase difference lines in a phase difference detection region, on the basis of a detection result which is obtained by the detection unit.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
an imaging device that includes a plurality of pairs of phase difference detection pixels, where a plurality of phase difference lines along pupil division directions is disposed in an orthogonal direction which is orthogonal to the pupil division direction;
a detection unit that detects an abnormal value among output values, which are output by the phase difference detection pixels, on the basis of a result of comparison of the output values between the plurality of phase difference lines; and
a phase difference line determination unit that determines, as used lines, a plurality of phase difference lines, which are used in phase difference detection, among the plurality of phase difference lines in a phase difference detection region, on the basis of a detection result which is obtained by the detection unit.

2. The imaging apparatus according to claim 1, wherein the phase difference line determination unit determines the used lines by excluding an abnormal value line, which is a phase difference line including the phase difference detection pixel that outputs the abnormal value, from the plurality of phase difference lines.

3. The imaging apparatus according to claim 2, wherein the detection unit calculates a line total for each of the phase difference lines by performing computation using the output values of the phase difference detection pixels included in the phase difference line, and detects the abnormal value line on the basis of a result of comparison between the line totals.

4. The imaging apparatus according to claim 3, wherein the detection unit detects the abnormal value line on the basis of a result of comparison between a predetermined threshold value and the line totals, sets a new region when detecting a plurality of the abnormal value lines, and detects the abnormal value line on the basis of a result of comparison between the line totals in the new region.

5. The imaging apparatus according to claim 3, wherein the detection unit calculates the line total for each of a base region and a reference region which are set to perform correlation calculation in a phase difference detection target region including the plurality of phase difference lines, and detects the abnormal value line for each of the base region and the reference region.

6. The imaging apparatus according to claim 5, wherein the detection unit detects the abnormal value line in the base region on the basis of the line total which is obtained by adding the output values of one of the pair of phase difference detection pixels, and detects the abnormal value line in the reference region on the basis of the line total which is obtained by adding the output values of the other of the pair of phase difference detection pixels.

7. The imaging apparatus according to claim 1, wherein the phase difference line determination unit determines whether or not it is possible to perform the phase difference detection using alternative candidates as the output values of the phase difference lines, which are disposed near the abnormal value line as the phase difference line including the phase difference detection pixel that outputs the abnormal value, instead of the output values of the abnormal value line, and determines the plurality of phase difference lines, which include the abnormal value line, as the used lines on the basis of the detection result which is obtained by the detection unit when determining that it is possible to perform the phase difference detection.

8. The imaging apparatus according to claim 7,
wherein in the imaging device, a plurality of phase difference detection pixels corresponding to any of a plurality of exit pupils, of which positions are different in an optical axis direction, is disposed,
wherein in the phase difference lines, the phase difference detection pixels are arranged such that one phase difference line corresponds to the exit pupil at one position, and the phase difference lines are arranged to respectively correspond to the exit pupils different from the exit pupils corresponding to the phase difference lines adjacent in the orthogonal direction, and
wherein a focusing determination unit sets the output values of the phase difference line, of which the corresponding exit pupil is closer to the exit pupil corresponding to the abnormal value line, between the two phase difference lines, which are adjacent to the abnormal value line in the orthogonal direction, as the alternative candidates.

9. The imaging apparatus according to claim 7,
wherein in the imaging device, a plurality of phase difference detection pixels corresponding to any of a plurality of exit pupils, of which positions are different in an optical axis direction, is disposed,
wherein in the phase difference lines, the phase difference detection pixels are arranged such that one phase difference line corresponds to the exit pupil at one position, and the phase difference lines are arranged to respectively correspond to the exit pupils different from the exit pupils corresponding to the phase difference lines adjacent in the orthogonal direction, and
wherein the phase difference line determination unit calculates the alternative candidates by computing the output values of the two phase difference lines which are adjacent to the abnormal value line in the orthogonal direction.

10. An imaging method comprising:
acquiring output values which are output by phase difference detection pixels of an imaging device that includes a plurality of pairs of phase difference detection pixels, where a plurality of phase difference lines along pupil division directions is disposed in an orthogonal direction which is orthogonal to the pupil division direction;
detecting an abnormal value among output values, which are output by the phase difference detection pixels, on the basis of a result of comparison of the output values between the plurality of phase difference lines; and
determining, as used lines, a plurality of phase difference lines, which are used in phase difference detection, among the plurality of phase difference lines in a phase difference detection region, on the basis of a detection result which is obtained in the detecting of the abnormal value.
